(19) United States
(12) Patent Application Publication
(10) Pub. No.: US 2018/0063490 A1
(43) Pub. Date: Mar. 1, 2018

(54) PROJECTOR

(71) Applicant: SEIKO EPSON CORPORATION, Tokyo (JP)

(72) Inventor: Makoto OTANI, Matsumoto-Shi (JP)

(73) Assignee: SEIKO EPSON CORPORATION, Tokyo (JP)

(21) Appl. No.: 15/558,025

(22) PCT Filed: Feb. 9, 2016
(86) PCT No.: PCT/JP2016/000671

§ 371 Date: Sep. 13, 2017

(30) Foreign Application Priority Data
Mar. 20, 2015 (JP) 2015-057419

(51) Int. Cl. H04N 9/31; G02B 13/00; G02B 17/08; G02B 5/10; G02B 26/08

(52) U.S. Cl. CPC H04N 9/317; H04N 9/3105; H04N 9/3126; G02B 26/0816; G02B 17/08; G02B 5/10; G02B 13/0095

(57) ABSTRACT

The projector includes a light source device, a first optical modulation device which modulates light emitted from the light source device and emits modulated light as first modulated light, a second optical modulation device which modulates the first modulated light and emits the first modulated light as second modulated light, a optical projection device projecting the second modulated light, and a relay device provided on an optical path between the first optical modulation device and the second optical modulation device, and the relay device includes an image forming lens which forms an image of the first modulated light on a modulation surface of the second optical modulation device and a reflection member disposed at a pupil position of the image forming lens and reflecting the incident first modulated light, and the reflection member has a scattering structure which scatters the first modulated light.

### TECHNICAL FIELD

The present invention relates to a projector.

### BACKGROUND ART

In the related art, a projector which modulates light emitted from a light source, forms an image according to image information, and enlarges and projects the image on a surface to be projected such as a screen is known. As the projector, a projector with two spatial modulation element arranged in series is known (for example, see PTL 1).

In the projector described in PTL 1, in addition to matters that two or more spatial modulation elements (color modulation light valve and brightness modulation light valve) are disposed in series, a relay optical system is provided between these spatial modulation elements. Light emitted from one spatial modulation element (color modulation light valve) is incident on the other spatial modulation element (brightness modulation light valve) through the relay optical system. With this, contrast of the formed and projected image is enhanced.

In the projector described in PTL 1, the relay optical system does not completely form an image of one spatial modulation element on the other spatial modulation element and is in a defocused state. With this, occurrence of moire due to a black matrix between pixels of the spatial modulation element is prevented.

### CITATION LIST

### Patent Literature

PTL 1: JP-A-2007-218946

### SUMMARY OF INVENTION

### Technical Problem

However, a defocused image depends on alignment distribution of light incident on the one spatial modulation element in the projector described in PTL 1. For that reason, in a case where light distribution is discrete (for example, after passing through an integrator system), the defocused image becomes also discrete, the black matrix between pixels of the spatial modulation element is hard to erase, and moire is easy to occur, which are problematic. In a case where deviation in light distribution is generated by positional deviation of a light source or the like, change in illumination distribution occurs or a defect such as a stripe which is not originally present in a projection image occurs.

The invention is intended to solve at least one of the problems to be solved and one of the objects thereof is to provide a projector capable of preventing an occurrence of disturbance in an image.

### Solution to Problem

A projector according to an aspect of the invention includes a light source device, a first optical modulation device which modulates light emitted from the light source device and emits modulated light as first modulated light, a second optical modulation device which modulates the first modulated light and emits the first modulated light as second modulated light, a projection optical device projecting the second modulated light, and a relay device provided on an optical path between the first optical modulation device and the second optical modulation device, and the relay device includes an image forming lens which forms an image of the first modulated light on a modulation surface of the second optical modulation device and a reflection member disposed at a pupil position of the image forming lens and reflecting the incident first modulated light, and the reflection member scatters the first modulated light.

According to the aspect, the reflection member disposed at a pupil position of the image forming lens which forms an image of the incident first modulated light on a modulation surface of the second optical modulation device scatters the incident first modulated light. According to this, an image of first modulated light due to the first optical modulation device can be incident on the modulation surface of the second optical modulation device in a blurred state and first modulated light due to a pixel of the first optical modulation device can be incident on a wide range including a corresponding pixel in the second optical modulation device. For that reason, it is possible to allow illumination distribution of light incident on the second optical modulation device to be illumination distribution which does not depend on light distribution and thus, in a case where the second optical modulation device includes a black matrix, it is possible to easily eliminate the black matrix, eventually, to prevent moire from occurring in the projection image. Furthermore, even in a case where alignment distribution of light incident on the first optical modulation device is changed, it is possible to prevent a stripe, which is not originally present in a projection image from occurring in the projection image. Accordingly, it is possible to prevent the projection image from being disturbed.

In the aspect, it is preferable that the reflection member includes a reflection surface reflecting the incident first modulated light and unevenness is formed on the reflection surface.

According to the aspect, it is possible to relatively easily configure a scattering structure. Accordingly, the scattering structure can be simplified and thus, it is possible to prevent an increase in manufacturing cost of the projector.

In the aspect, it is preferable that the unevenness formed on the reflection surface is a curved surface shape.

According to the aspect, it is possible to prevent first modulated light from being reflected on a deviated position by the reflection surface. Accordingly, it is possible to uniformly illuminate a relatively wide range including the corresponding pixel in the second optical modulation device and thus, it is possible to set illumination distribution which does not depend on light distribution and prevent the projection image from being disturbed even in a case where deviation in alignment distribution of light incident on the first optical modulation device is generated.

In the aspect, it is preferable that the reflection member is a deformable mirror in which the unevenness of the reflection surface is variable.

According to the aspect, the reflection member is a deformable mirror and thus, it is possible to allow the reflection surface to be changed with time. According to this, it is possible to surely scatter first modulated light to be incident on the second optical modulation device and thus, it is possible to allow the image of the first modulated light due to the first optical modulation device to be surely incident on the modulation surface of the second optical modulation device in a blurred state. Accordingly, it is possible to surely prevent disturbance from occurring in the image.

In the aspect, it is preferable that the reflection member includes a reflection surface reflecting the incident first modulated light and a driving portion rotating the reflection surface around a first rotation axis along a first direction which intersects with a central axis of the incident first modulated light.

According to the aspect, the reflection surface reflecting first modulated light is rotated around the first rotation axis by the driving portion. According to this, it is possible to surely scatter the first modulated light to be incident on the modulation surface of the second optical modulation device. Accordingly, it is possible to surely prevent disturbance from occurring in the image.

In the aspect, it is preferable that the driving portion rotates the reflection surface around each of the first rotation axis along the first direction and a second rotation axis along a second direction which is substantially orthogonal to the first rotation axis, and a frequency of rotation around the first rotation axis is different from the frequency of rotation around the second rotation axis.

According to the aspect, the driving portion rotates the reflection surface as described above to thereby make it possible to move the center position of first modulated light for each pixel of the first optical modulation device to everywhere within a movable range of the center position. According to this, it is possible to uniformly illuminate a wide range including the corresponding pixel in the second optical modulation device by first modulated light for each pixel. Accordingly, it is possible to more surely prevent disturbance from occurring in the image.

In the aspect, it is preferable that the driving portion changes at least one of an amount of rotation of the reflection surface around the first rotation axis and an amount of rotation of the reflection surface around the second rotation axis with the lapse of time.

According to the aspect, it is possible to more surely distribute and dispose the center position of first modulated light for each pixel of the first optical modulation device within the movable range of the center position. Accordingly, it is possible to more uniformly illuminate a wide range including the corresponding pixel in the second optical modulation device and thus, it is possible to more surely prevent disturbance from occurring in the image.

### BRIEF DESCRIPTION OF DRAWINGS

FIG. 1 is a schematic diagram illustrating an internal configuration of a projector according to a first embodiment of the invention.

FIG. 2 is a diagram illustrating an optical path of light emitted from a brightness adjustment light valve and incident on a corresponding color modulation light valve in the first embodiment.

FIG. 3 is a diagram illustrating a cross-section of a reflection member in the first embodiment.

FIG. 4 is a cross-sectional view illustrating a variation of the reflection member in the first embodiment.

FIG. 5 is a diagram illustrating a reflection member included in a projector according to a third embodiment of the invention.

FIG. 6 is a schematic diagram illustrating a locus of light incident on a reflection member included in a projector according to a fourth embodiment of the invention.

FIG. 7 is a schematic diagram illustrating a configuration of a reflection plate in the fourth embodiment.

FIG. 8 is a time chart illustrating an amount of movement of a center position of first modulated light in the fourth embodiment.

FIG. 9 is a diagram illustrating a locus of the center position of the first modulated light in the fourth embodiment.

FIG. 10 is a diagram illustrating illuminance distribution of first modulated light in the fourth embodiment.

FIG. 11 is a graph illustrating illuminance distribution of the first modulated light in the fourth embodiment.

FIG. 12 is a time chart illustrating an amount of movement of a center position of first modulated light in a fifth embodiment of the invention.

FIG. 13 is a diagram illustrating a locus of the center position of first modulated light in the fifth embodiment.

FIG. 14 is a diagram illustrating illuminance distribution of first modulated light in the fifth embodiment.

FIG. 15 is a graph illustrating illuminance distribution of first modulated light in the fifth embodiment.

FIG. 16 is a time chart illustrating an amount of movement of a center position of first modulated light in modification of the fifth embodiment.

FIG. 17 is a diagram illustrating the locus of the center position of first modulated light in modification of the fifth embodiment.

FIG. 18 is a diagram illustrating illuminance distribution of first modulated light in modification of the fifth embodiment.

FIG. 19 is a graph illustrating illuminance distribution of first modulated light in modification of the fifth embodiment.

FIG. 20 is a schematic diagram illustrating a configuration of a projector according to a sixth embodiment of the invention.

FIG. 21 is a schematic diagram illustrating a configuration of a projector according to a seventh embodiment of the invention.

FIG. 22 is a diagram illustrating an optical path of a light-control device in the seventh embodiment.

FIG. 23 is a schematic diagram illustrating a configuration of a projector according to an eighth embodiment of the invention.

FIG. 24 is a schematic diagram of an internal structure of a projector according to a ninth embodiment of the invention when viewed from a side.

FIG. 25 is a plan view illustrating an illumination device, a color separation device, and a total reflection mirror positioned at an upper stage in the ninth embodiment.

FIG. 26 is a plan view illustrating a light-control device, an image forming device, and a projection optical device positioned at a lower stage in the ninth embodiment.

FIG. 27 is a schematic diagram of an internal structure of a projector according to a tenth embodiment of the invention when viewed from a side.

FIG. 28 is a plan view illustrating a portion of an illumination device, a color separation device, and a light-control device positioned at the upper stage in the tenth embodiment.

FIG. 29 is a plan view illustrating a portion of the light-control device, an image forming device, and a projection optical device positioned at the lower stage in the tenth embodiment.

### DESCRIPTION OF EMBODIMENTS

### First Embodiment

In the following, a first embodiment of the invention will be described with reference to the drawings.

### [Configuration of Projector]

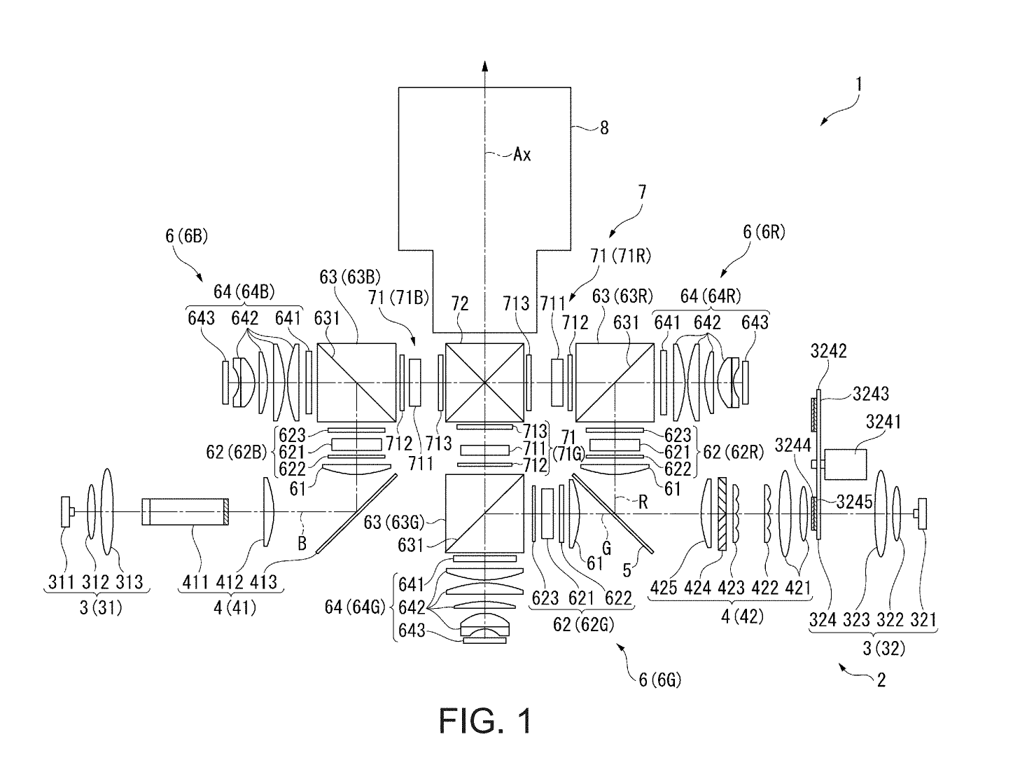

FIG. 1 is a schematic diagram illustrating an internal configuration of a projector 1 according to the present embodiment.

The projector 1 according to the present embodiment is a projector which modulates light emitted from a light source disposed inside thereof, forms an image according to image information, and enlarges and projects the image on a surface to be projected such as a screen.

As illustrated in FIG. 1, the projector 1 includes an illumination device 2, a color separation device 5, three light-control devices 6 (6R, 6G, and 6B), an image forming device 7, a projection optical device 8, and an outer casing (not illustrated) accommodating these devices 2 to 8. In addition to the devices, the projector 1, includes although illustration is omitted, a control device controlling an operation of the projector 1, a power supply device supplying power to electronic components of the projector 1, and a cooling device which cools down a cooling target.

Although details will be described later, in such a projector 1, light (first modulated light) obtained by allowing light incident from the illumination device 2 to be modulated for each pixel by a brightness adjustment light valve 62 of the light-control device 6 is incident on a corresponding pixel in a color modulation light valve 71 of the image forming device 7, is further modulated by the color modulation light valve 71, and an image according to the image information is formed and projected. With this, contrast of a projection image is enhanced.

In the projector 1, an image forming lens 642 of a relay device 64 positioned on an optical path between the brightness adjustment light valve 62 and the color modulation light valve 71 forms an image of the brightness adjustment light valve 62 on an image forming surface 7111 of the color modulation light valve 71. A reflection member 643 of the relay device 64 scatters an image of first modulated light of each pixel (in the following, may be referred to as light-control pixel) of the brightness adjustment light valve 62 to be incident on a corresponding pixel in the image forming surface 7111. With this, an illumination range of first modulated light due to a light-control pixel incident on the corresponding pixel is enlarged, it becomes easy to erase the black matrix in the image forming surface 7111 of the color modulation light valve 71, and disturbance such as moire is prevented from occurring in a projected image.

In the following, respective configurations of the projector 1 will be described.

### [Configuration of Illumination Device]

The illumination device 2 includes alight source device 3 and a uniformizing device 4, and emits light including color light beams of red, green, and blue. Among these devices, the light source device 3 includes a first light source device 31 emitting blue light beam B and a second light source device 32 emitting fluorescent light including green light beam G red light beam R, and the uniformizing device 4 includes a first uniformizing device 41 provided according to the first light source device 31 and second uniformizing device 42 provided according to the second light source device 32.

### [Configuration of First Light Source Device and First Uniformizing Device]

The first light source device 31 includes a solid-state light source 311 emitting the blue light beam B, a collimating lens 312 collimating the blue light beam B emitted from the solid-state light source 311, and a condensing lens 313 condensing the blue light beam B, which is incident from the collimating lens 312, and emitting the blue light beam B to the first uniformizing device 41.

Among these components, the solid-state light source 311 emits the blue light beam B which is one polarization beam (p-polarization in the present embodiment) among p-polarization and s-polarization. A laser diode (LD) or a light emitting diode (LED) may be adopted as the solid-state light source.

The first uniformizing device 41 uniformizes illuminance distribution (brightness distribution) within a plane orthogonal to the central axis of the blue light beam B incident from the first light source device 31. The first uniformizing device 41 includes a rod integrator 411, a condensing lens 412, and a total reflection mirror 413.

The rod integrator 411 is made of translucent material such as glass, has a rectangular cross-sectional shape, and causes the blue light beam B incident from the first light source device 31 to be repeatedly subjected to internal reflection to thereby uniformize illuminance distribution within the plane of the blue light beam B. Thereafter, the blue light beam B is incident on the total reflection mirror 413 through the condensing lens 412 and is reflected toward a light-control device 6B for blue.

### [Configuration of Second Light Source Device and Second Uniformizing Device]

The second light source device 32 includes a solid-state light source 321 emitting excitation light, a collimating lens 322, a condensing lens 323, and a wavelength conversion device 324.

The solid-state light source 321 is an LD emitting a blue light beam as excitation light and excitation light emitted from the solid-state light source 321 is incident on a rotation fluorescent plate 3242 of the wavelength conversion device 324 through the collimating lens 322 and the condensing lens 323.

The wavelength conversion device 324 converts a wavelength of incident light and emits incident light. The wavelength conversion device 324 includes a rotation device 3241 and a rotation fluorescent plate 3242 rotated by the rotation device 3241.

The rotation device 3241 is configured with a wheel motor rotating the rotation fluorescent plate 3242 around the central axis of the rotation fluorescent plate 3242 as a rotation axis. The rotation fluorescent plate 3242 is rotated by the rotation device 3241 to thereby cool down the rotation fluorescent plate 3242.

In the rotation fluorescent plate 3242, a phosphor layer 3244 converting the wavelength of incident light is formed on a disk 3243 rotated by the rotation device 3241 along a circumferential direction of the disk 3243. The rotation fluorescent plate 3242 emits fluorescent light including red light beam R and green light beam G toward a side opposite to a side on which excitation light is incident.

The disk 3243 is made of the material transmitting the blue light beam. As the material of the disk 3243, for example, quartz glass, crystal, sapphire, optical glass, and transparent resin may be cited.

Excitation light emitted from the solid-state light source 321 is incident on the phosphor layer 3244 from the disk 3243. A dichroic film 3245 transmitting the blue light beam and reflecting the red light beam R and the green light beam G is provided between the phosphor layer 3244 and the disk 3243.

The phosphor layer 3244 converts the wavelength of the excitation light to be fluorescent light including the red light beam R and the green light beam G. Such a phosphor layer 3244 is, for example, a layer containing a YAG-based phosphor (Y, Gd)₃ (Al, Ga)₅O₁₂: Ce.

Fluorescent light of which the wavelength is converted in the phosphor layer 3244 is scattered and a portion of light beams is emitted from the phosphor layer 3244 to a disk 3243 side. However, the portion of light beams is reflected by the dichroic film 3245. With this, the red light beam R and the green light beam G included in the fluorescent light are emitted to a second uniformizing device 42 side.

The second uniformizing device 42 uniformizes intensity distribution (illuminance distribution) within the plane orthogonal to the central axis of the fluorescent light incident from the second light source device 32. The second uniformizing device 42 includes a collimating lens 421, a first lens array 422, a second lens array 423, a polarization conversion element 424, and a superimposed lens 425.

The collimating lens 421 is a convex lens and substantially collimates light incident from the second light source device 32.

The first lens array 422 includes, although illustration is omitted, a plurality of first small lenses dividing light incident from the collimating lens 421 into a plurality of partial light fluxes. These first small lenses are arranged in a matrix within the plane orthogonal to an illumination optical axis Ax (central axis of light incident from second light source device 32 among optical axes in designing).

The second lens array 423 includes, although illustration is omitted, a plurality of second small lenses corresponding to the plurality of first small lenses. The second lens array 423 together with the superimposed lens 425 forms images of each of the first small lenses on a modulation surface 6211 of a liquid crystal panel 621 constituting each of brightness adjustment light valves 62R and 62G of the light-control device 6 which will be described later. These second small lenses are also arranged in a matrix within the plane orthogonal to the illumination optical axis Ax.

The polarization conversion element 424 has a function of making polarizing directions of respective partial light fluxes incident from the second lens array 423 uniform.

Specifically, the polarization conversion element 424 includes a polarization separation layer which, among incident light beams, transmits one linearly polarized light component and reflects the other linearly polarized light components in a direction orthogonal to an advancing direction of the linearly polarized light component of the one linearly polarized light component, a reflection layer which reflects the other linearly polarized light components reflected by the polarization separation layer in a direction parallel to the advancing direction of the one linearly polarized light component, and a phase difference layer converts the other linearly polarized light components reflected by the reflection layer into the one linearly polarized light component. In the present embodiment, the polarization conversion element 424 is configured to emit p-polarization, but may be configured to emit s-polarization.

### [Configuration of Color Separation Device]

The color separation device 5 separates green light beam G and red light beam R from fluorescent light incident from the second uniformizing device 42. Specifically, the color separation device 5 is configured with a dichroic mirror which transmits the green light beam G and reflects the red light beam R. The green light beam G separated by the color separation device 5 is incident on the light-control device 6G for green light and the red light beam R is incident on the light-control device 6R for red light.

### [Configuration of Light Control Device]

The light-control device 6 is controlled by the control device and adjusts illuminance distribution (brightness distribution) within a plane orthogonal to the central axis of incident light according to image information. Among the light-control devices 6, the blue light beam B reflected by the total reflection mirror 413 is incident on the light-control device 6B for blue light beam and the green light beam G and the red light beam R separated by the color separation device 5 are respectively incident on the light-control device 6G for green light and the light-control device 6R for red light.

Each light-control device 6 includes a field lens 61, a brightness adjustment light valve 62, a polarization separation device 63, and a relay device 64.

Among these components, the field lens 61 has a function of emitting incident light by making the advancing direction of incident light uniform.

### [Configuration of Brightness Adjustment Light Valve]

The brightness adjustment light valve 62 (brightness adjustment light valves for blue, green, and red are respectively set as 62B, 62G, and 62R) corresponds to a first optical modulation device of the invention. Each of these brightness adjustment light valves 62 includes a transmission type liquid crystal panel 621 and an incidence side polarization plate 622 and an emission side polarization plate 623 that sandwich the liquid crystal panel 621.

Each of the brightness adjustment light valve 62 modulates light incident through the incidence side polarization plate 622 for each area by the liquid crystal panel 621 controlled by the control device and modulated light is emitted through the emission side polarization plate 623 to thereby allow illuminance distribution within the plane orthogonal to the central axis to be adjusted. By doing this, light (first modulated light) of which brightness is adjusted by the brightness adjustment light valve 62 is incident on a corresponding polarization separation device 63.

### [Configuration of Polarization Separation Device]

The polarization separation device 63 (polarization separation devices for blue, green, and red are respectively set as 63B, 63G, and 63R) is a prism type polarizing beam splitter (PBS) inside of which a polarization separation layer 631, which transmits one linearly polarized light component and reflects other linearly polarized light component among incident light beams, is disposed. Each of the polarization separation devices 63 reflects first modulated light, which is incident from a corresponding brightness adjustment light valve 62 and is s-polarization, toward the relay device 64 and causes first modulated light, which is incident from the relay device 64 and is p-polarization, to be incident on the color modulation light valve 71 constituting the image forming device 7.

### [Configuration of Relay Device]

The relay device 64 (relay devices for blue, green, and red are respectively set as 64B, 64G, and 64R) has a function of forming an image of first modulated light incident from the polarization separation device 63 on the corresponding color modulation light valve 71. Each of the relay devices 64 includes a phase difference plate 641, an image forming lens 642, and a reflection member 643.

The phase difference plate 641 is a λ/4 plate and gives a phase difference to incident light and changes polarization. First modulated light is incident on the phase difference plate 641 two times of at the time when first modulated light is incident on the relay device 64 from the polarization separation device 63 and at the time when first modulated light reflected by the reflection member 643 of the relay device 64 is incident on the polarization separation device 63. For that reason, first modulated light of s-polarization which is incident on the relay device 64 from the polarization separation device 63 becomes first modulated light of p-polarization on the way of passing through the relay device 64 and is incident on the polarization separation device 63. First modulated light of p-polarization passes through the polarization separation layer 631 of the polarization separation device 63 and is incident on the corresponding color modulation light valve 71.

The image forming lens 642 together with the reflection member 643 forms an image of incident first modulated light on the corresponding color modulation light valve 71. The image forming lens 642 has the same lens configuration as one of a front-stage lens group and a rear-stage lens group in the relay device of the related art including the front-stage lens group, an aperture diaphragm, and the rear-stage lens group, and such a lens includes one of a meniscus lens and a double gauss lens.

The reflection member 643 reflects first modulated light incident from the polarization separation device 63 to be reciprocated and causes the first modulated light to be incident on the polarization separation device 63 again. The reflection member 643 is disposed at an optical pupil position of the image forming lens 642.

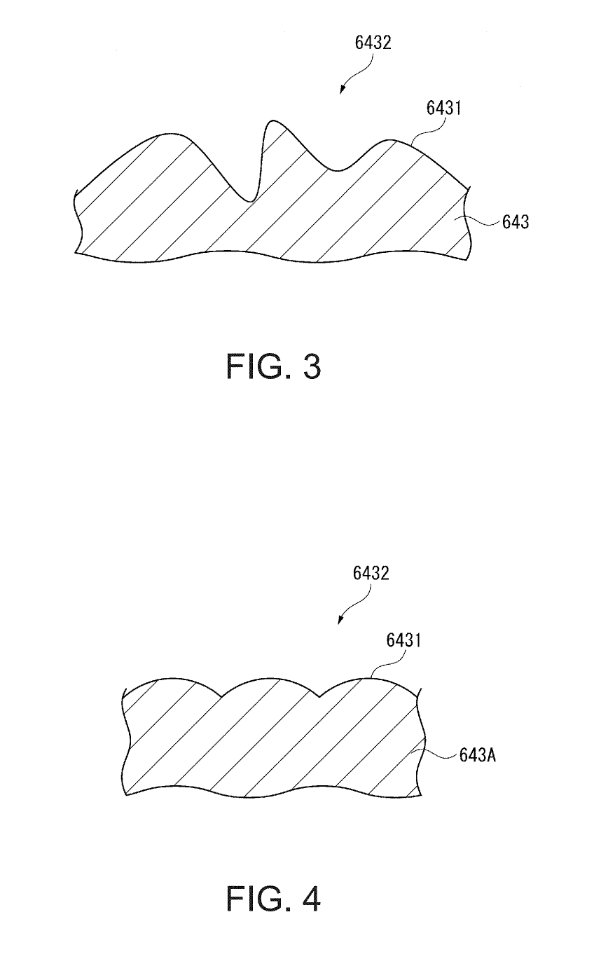

Such a reflection member 643 includes a reflection surface 6431 reflecting first modulated light and although details will be described later, unevenness 6432 (see FIG. 3) which is fine and amorphous is formed on the reflection surface 6431 as a scattering structure. The reflection member 643 scatters first modulated light of which image is formed on the corresponding color modulation light valve 71 by the image forming lens 642.

As such, in the present embodiment, the relay device 64 has a structure in which incident first modulated light is returned by the reflection member 643 and thus, it is possible to achieve miniaturization of the relay device 64 compared to a case where the relay device, in which the front-stage lens group, the aperture diaphragm, and the rear-stage lens group are disposed in series, and first modulated light is passed through these components in one direction.

### [Configuration of Image Forming Device]

The image forming device 7 further modulates first modulated light beams of blue, green, and red incident through respective light-control devices 6, forms images according to pieces of image information, and combines these images to form a projection image projected by the projection optical device 8. The image forming device 7 includes three color modulation light valves 71 provided according to color light beams incident from respective light-control devices 6 and a single color combining device 72.

### [Configuration of Color Modulation Light Valve]

The color modulation light valve 71 (color modulation light valves for blue, green, and red are respectively set as 71B, 71G, and 71R) corresponds to a second modulation device of the invention. Each of the color modulation light valves 71 modulates first modulated light of a corresponding color light beam and forms an image in accordance with image information (image of corresponding color light beam). Each of the color modulation light valves 71 includes a transmission type liquid crystal panel 711 and an incidence side polarization plate 712 and an emission side polarization plate 713 that sandwich the liquid crystal panel 711.

Each of the color modulation light valve 71 modulates first modulated light incident through the incidence side polarization plate 712 according to image information for each pixel by the liquid crystal panel 711 controlled by the control device and emits first modulated light, which is modulated, to the color combining device 72 through the emission side polarization plate 713 as second modulated light.

In the present embodiment, the liquid crystal panel 711 has the same resolution as that of the liquid crystal panel 621 constituting the brightness adjustment light valve 62. For that reason, respective pixels of respective liquid crystal panels 621 and 711 correspond to each other and first modulated light modulated by a certain light-control pixel of the liquid crystal panel 621 is mainly incident on the corresponding color modulation pixel among pixels (in the following, may be referred to as color modulation pixel) of the liquid crystal panel 711. However, without being limited to the configuration described above, a configuration in which an area which is a unit of modulation of the liquid crystal panel 621 constituting the brightness adjustment light valve 62 is not set as a unit of a pixel but set as every plurality of pixels (for each pixel area) so as to make the number of the units of modulations smaller than resolution of the color modulation light valve 71 may be adopted.

### [Configuration of Color Combining Device]

The color combining device 72 combines respective second modulated light beams of blue, green, and red incident from respective color modulation light valve 71 to form the projection image and emits the projection image toward the projection optical device 8. In the present embodiment, the color combining device 72 is configured by a cross dichroic prism including three incident surfaces and one emission surface, and each incident surface faces corresponding color modulation light valve 71 and the emission surface faces the projection optical device 8.

### [Configuration of Projection Optical Device]

The projection optical device 8 enlarges and projects the projection image incident from the color combining device on the surface to be projected described above. The projection optical device 8 is configured with, although illustration is omitted, a barrel and a group lens including a plurality of lenses accommodated and disposed within the barrel.

### [Configuration of Reflection Member]

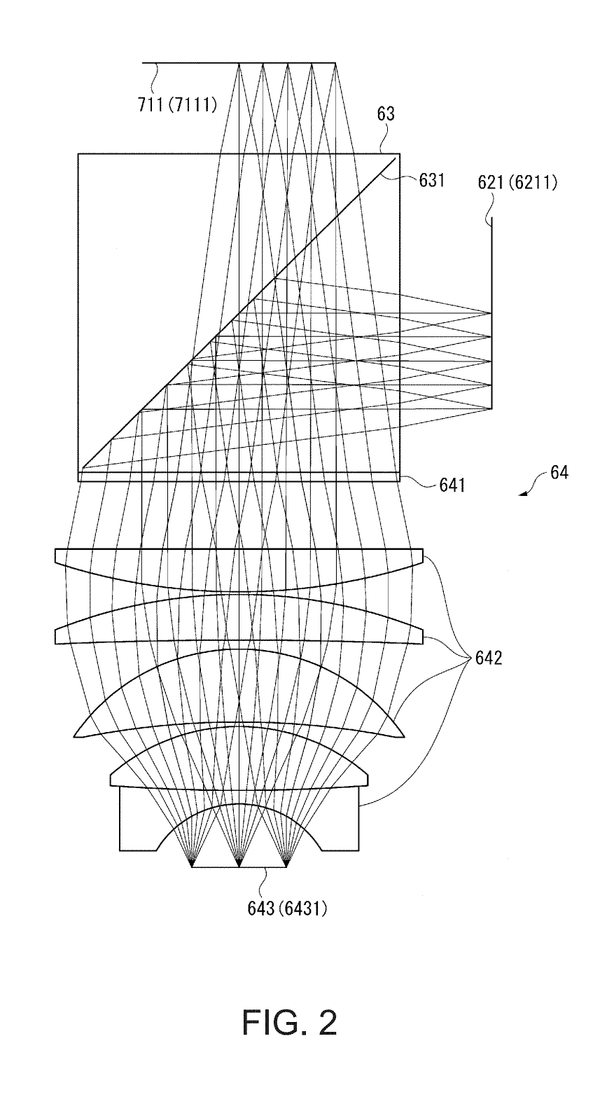

FIG. 2 is a diagram illustrating an optical path of light emitted from a modulation surface 6211 of the liquid crystal panel 621 constituting the brightness adjustment light valve 62 and is incident on the image forming surface 7111 which is a modulation surface of the liquid crystal panel 711 constituting the corresponding color modulation light valve 71. In FIG. 2, by considering easiness to see, a portion of light emitted from the modulation surface 6211 and incident on the image forming surface 7111 is omitted.

As described above, first modulated light emitted from the brightness adjustment light valve 62 is incident on the color modulation light valve 71. Specifically, as illustrated in FIG. 2, an image of first modulated light emitted from the modulation surface 6211 of the liquid crystal panel 621 constituting the brightness adjustment light valve 62 is formed on the image forming surface 7111 of the liquid crystal panel 711 constituting the color modulation light valve 71 by the image forming lens 642 on the way of passing through the polarization separation device 63 and the relay device 64.

However, when an image of first modulated light is completely formed on the image forming surface 7111 by the image forming lens 642, there is a concern that occurrence of disturbance such as occurrence of moire is caused when alignment distribution of light from the light source is changed, in addition to matters that the black matrix becomes prominent in the projection image.

FIG. 3 is a diagram illustrating a cross-section of the reflection member 643.

In contrast, in the present embodiment, as illustrated in FIG. 3, the reflection surface 6431 of the reflection member 643 is set as a curved surface shape and unevenness 6432 which is fine and random unevenness is formed on the reflection surface 6431. With this, first modulated light reflected by the reflection surface 6431 is scattered and incident on the image forming surface 7111. With this, it is possible to enlarge an illumination range of first modulated light emitted from the light-control pixel and incident on a corresponding color modulation pixel. Accordingly, disturbance of an image such as of moire is prevented from occurring, in addition to matters that the black matrix becomes prominent in the projection image.

According to the projector 1 according to the present embodiment as described above, the following effects are obtained.

The reflection member 643 positioned at the pupil position of the image forming lens 642, which forms an image of incident first modulated light on the image forming surface 7111 of the color modulation light valve 71, scatters the incident first modulated light. According to this, the first modulated light is scattered by the reflection member 643, in addition to matters that the image of first modulated light by the brightness adjustment light valve 62 is incident on the image forming surface 7111 in a blurred state. According to this, it is possible to allow blurred illumination distribution which does not depend on light distribution. Accordingly, it is possible to prevent disturbance such as moire from occurring in the image projected by the projection optical device 8. Since it is not dependent on light distribution, even in a case where deviation in alignment distribution of light incident on the brightness adjustment light valve 62 is generated, it is possible to prevent a defect such as a stripe which is not originally present in a projection image itself from occurring in the projection image.

The unevenness 6432 is formed on the reflection surface 6431 of the reflection member 643. According to this, it is possible to relatively easily configure the scattering structure. Accordingly, the scattering structure can be simplified and thus, it is possible to prevent an increase in manufacturing cost of the projector 1.

The reflection surface 6431 of the reflection member 643 is formed with a curved surface shape including the unevenness 6432. According to this, it is possible to prevent first modulated light from being reflected on a deviated position by the reflection surface 6431. Accordingly, since it is possible to illuminate uniformly a relatively wide range including the corresponding color modulation pixel in the color modulation light valve 71, even in a case where deviation in alignment distribution of light incident on the brightness adjustment light valve 62 is generated, it is possible to preferably prevent disturbance of an image such as moire from occurring.

### Variation of First Embodiment

FIG. 4 is a cross-sectional view illustrating a reflection member 643A which is a variation of the reflection member 643.

In the projector 1 described above, the reflection member 643 was configured to include the unevenness 6432 which is fine and random unevenness in the reflection surface 6431. However, unevenness formed on the reflection surface 6431 is not limited to the shape of the unevenness 6432.

For example, as illustrated in FIG. 4, the reflection member 643A in which convex portions having a convex lens shape (arc shaped cross-section) are formed repeatedly and regularly on the reflection surface 6431 such that the unevenness 6432 is formed on the reflection surface 6431 may be adopted. Such convex portions are preferably arranged in a matrix along each of two axes orthogonal to each other within a plane of the reflection surface 6431.

Even in a case where such a reflection member 643A is used, the same effect as that of the projector 1 described above can be obtained.

### Second Embodiment

In the following, a second embodiment of the invention will be described.

A projector according to the present embodiment has the same configuration as that of the projector 1 described above. Here, in the projector 1, the unevenness 6432 is formed on the reflection surface 6431 to thereby form unevenness, by which first modulated light incident on the image forming surface 7111 is scattered, on the reflection surface 6431 of the reflection member 643. In contrast, in the present embodiment, the reflection member is formed as a deformable mirror to thereby scatter first modulated light incident on the image forming surface 7111. In this regard, the projector according to the present embodiment is different from the projector 1 described above. In the following description, the same or substantially the same portions as previously described portions are assigned the same reference numerals and description thereof will be omitted.

The projector according to the present embodiment has the same configuration and function as those of the projector 1 described above except that the reflection member 643 is configured by the deformable mirror.

In the deformable mirror, although illustration is omitted, a plurality of actuators such as piezoelectric actuators are arranged on a rear surface of the reflection surface 6431 and the reflection surface 6431 is vibrated to allow the shape of the reflection surface 6431 to be changed with time. That is, the shape of unevenness of the reflection surface 6431 is changed with time in the reflection member 643 configured by the deformable mirror.

Even in a case where such a reflection member 643 is adopted, the same effect as that of the projector 1 described above can be obtained. The shape of unevenness formed on the reflection surface 6431 is changed by time to thereby make it possible to surely scatter first modulated light to be incident on the image forming surface 7111 and thus, it is possible to allow illumination distribution (blurred illumination distribution) which does not depend on light distribution. Accordingly, it is possible to surely prevent moire from occurring in the projection image. Furthermore, since it is not dependent on light distribution, even in a case where deviation in alignment distribution of light incident on the brightness adjustment light valve 62 is generated, it is possible to prevent a defect such as a stripe which is not originally present in a projection image itself from occurring in the projection image. Accordingly, it is possible to surely prevent disturbance from occurring in the projection image.

### Third Embodiment

Next, a third embodiment of the invention will be described.

A projector according to the present embodiment has the same configuration as that of the projector according to the second embodiment. Here, in the projector, the reflection member 643 is configured by the deformable mirror and the unevenness 6432 on the reflection surface 6431 is changed with time to thereby cause first modulated light incident on the image forming surface 7111 to be scattered. In contrast, in the present embodiment, a substrate having a reflection surface on which unevenness is formed is rotated in the reflection member and unevenness within a range in which first modulated light is incident is allowed to be changed with time to thereby cause first modulated light to be scattered. In this regard, the projector according to the present embodiment is different from the projector 1 described above. In the following description, the same or substantially the same portions as previously described portions are assigned the same reference numerals and description thereof will be omitted.

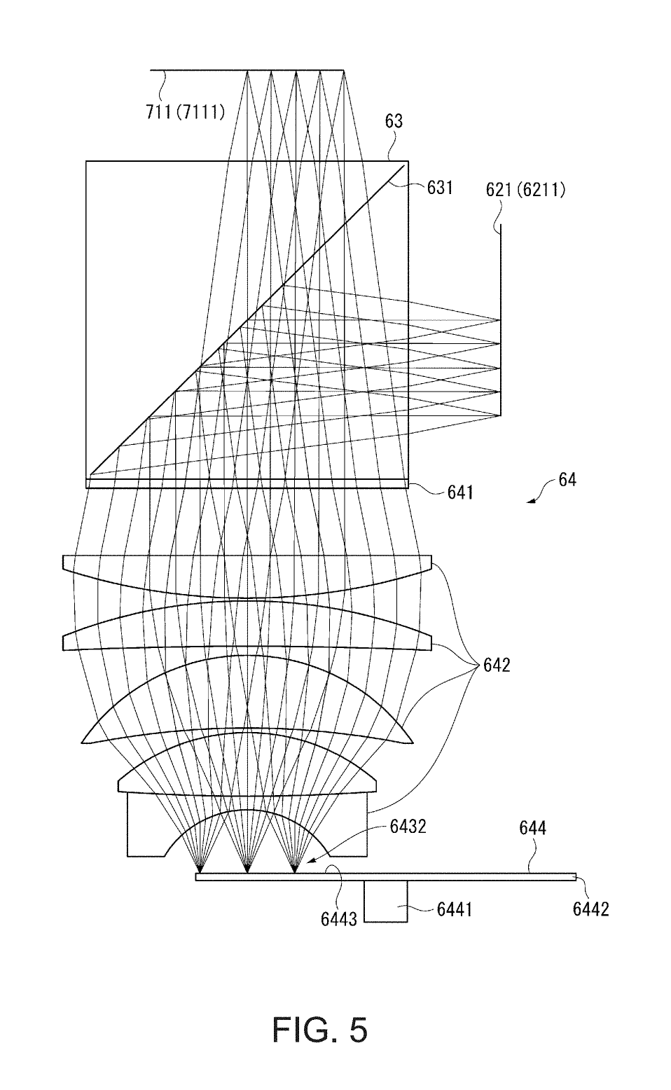

FIG. 5 is a diagram illustrating a reflection member 644 included in a projector according to the present embodiment. Also, in FIG. 5, by considering easiness to see, a portion of light beams emitted from the modulation surface 6211 and incident on the image forming surface 7111 is omitted.

The projector according to the present embodiment has the same configuration and function as those of the projector 1 described above, except that instead of the reflection member 643, the reflection member 644 is included.

The reflection member 644 corresponds to a member obtained by rotating the reflection member 643 and specifically, as illustrated in FIG. 5, includes a rotation device 6441 configured by a motor or the like and a substrate 6442.

Among these components, the substrate 6442 is formed in a circular shape when viewed from an image forming lens 642 side and is rotated by the rotation device 6441 around the rotation axis along the normal line passing through the center of the substrate 6442. The substrate 6442 includes a reflection surface 6443 reflecting and returning incident first modulated light to the image forming lens 642 side and the unevenness 6432 is formed on the reflection surface 6443.

When the substrate 6442 is rotated by the rotation device 6441, a shape of unevenness within the area on which first modulated light is incident from the image forming lens 642 is changed with time in the reflection surface 6443.

With this, similar to a case where the reflection member configured by the deformable mirror is adopted, first modulated light due to the light-control pixel is scattered to make it possible for first modulated light to be incident on the image forming surface 7111 and thus, it is possible to allow illumination distribution which does not depend on light distribution. Accordingly, in addition to matters that it is possible to more surely prevent moire from occurring in the projection image, even in a case where deviation in alignment distribution is generated, it is possible to prevent a defect such as a stripe which is not originally present in a projection image itself from occurring in the projection image. Accordingly, it is possible to surely prevent disturbance from occurring in the projection image.

According to the projector according to the present embodiment described above, the same effect as that of the projector described in the second embodiment can be obtained.

### Fourth Embodiment

Next, a fourth embodiment of the invention will be described.

The projector according to the present embodiment has the same configuration as that of the projector described in each of the first to third embodiments described above. Here, in the projectors described in the second and third embodiments, the reflection surface of the reflection member is moved to cause unevenness to be changed with time and allow incident first modulated light to be scattered. In contrast, in the projector according to the present embodiment, the reflection plate is rotated around two axes, which are orthogonal to the central axis of incident first modulated light and also orthogonal to each other, to thereby scatter the first modulated light. In this regard, the projector according to the present embodiment is different from the projector 1 described in the second and third embodiments. In the following description, the same or substantially the same portions as previously described portions are assigned the same reference numerals and description thereof will be omitted.

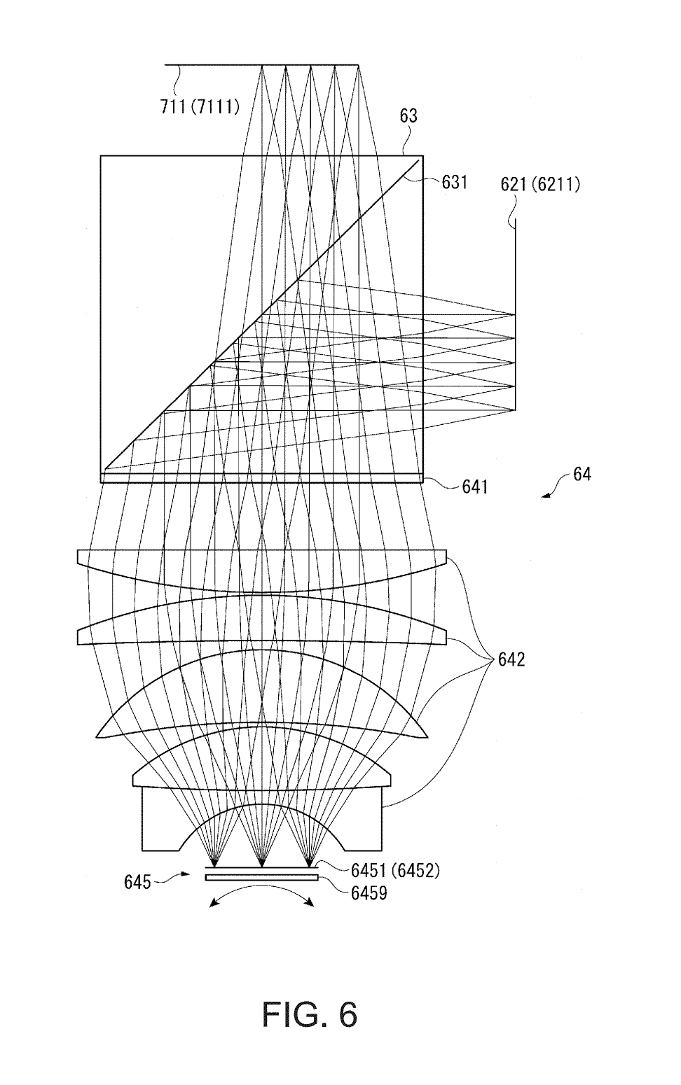

FIG. 6 is a schematic diagram illustrating a locus of reflected light which is incident on a reflection plate 6451 of a reflection member 645 included in the projector according to the present embodiment. Also, in FIG. 6, by considering easiness to see, a portion of light beams emitted from the modulation surface 6211 and incident on the image forming surface 7111 is omitted.

The projector according to the present embodiment has the same configuration and function as those of the projector 1 described above, except that instead of the reflection member 643, the reflection member 645 is included.

As illustrated in FIG. 6, the reflection member 645 includes a reflection plate 6451 having a flat reflection surface 6452 and a driving portion 6459 rotating the reflection plate 6451. In the reflection member 645, the reflection plate 6451 is rotated around the rotation axis along two directions (one is set as the X direction and the other is set as the Y direction), which respectively intersect with the central axis of first modulated light incident on the reflection surface 6452 and orthogonal to each other and first modulated light incident on the image forming surface 7111 is scattered, by the driving portion 6459.

The X direction and the Y direction respectively correspond to a first direction and a second direction of the invention.

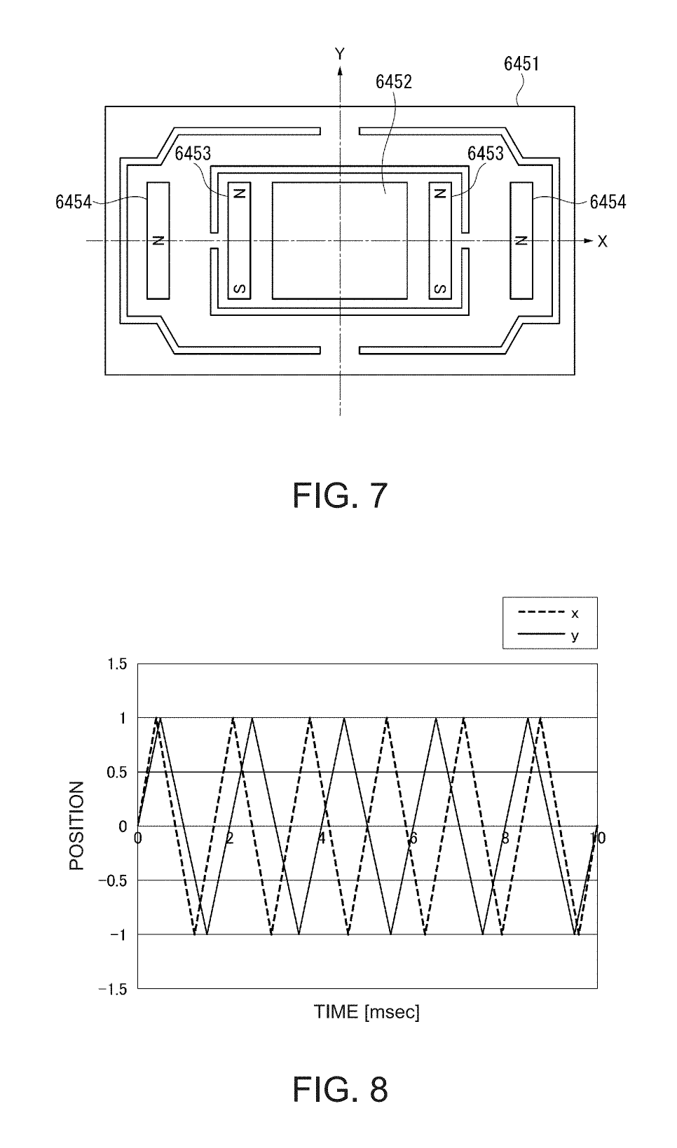

FIG. 7 is a schematic diagram illustrating a configuration of the reflection plate 6451.

As illustrated in FIG. 7, the reflection plate 6451 has a configuration in which the reflection surface 6452 is disposed in the center, a pair of magnets 6453 is disposed at positions between which the reflection surface 6452 is sandwiched, and a pair of magnets 6454 is disposed at positions between which the pair of magnets 6453 is sandwiched.

The driving portion 6459 feeds power to electromagnets arranged according to the pair of magnets 6453 and the pair of magnets 6454 so as to respectively rotate (incline) the reflection plate 6451 around a rotation axis along the X direction and another rotation axis along the Y direction in one direction or the other direction. That is, the driving portion 6459 scatters first modulated light incident on the reflection plate 6451.

FIG. 8 is a time chart illustrating an amount of movement of a center position of first modulated light due to one light-control pixel according to rotation of the reflection plate 6451 by the driving portion 6459. In FIG. 8, a case in which movement is performed in the X direction (+X direction) and the Y direction (+Y direction) by one pixel is set as “1” and a case in which movement is performed in a direction (−X direction) opposite to the X direction and a direction (−Y direction) opposite to the Y direction by one pixel is set as “−1” are represented.

The driving portion 6459 respectively rotates the reflection plate 6451 around the rotation axis along the Y direction and another rotation axis along the Y direction in one direction or the other direction to thereby allow the center position of first modulated light due to the light-control pixel to be reciprocated periodically in ±X direction by one pixel and ±Y direction by one pixel, as illustrated in FIG. 8.

Here, resolution of the liquid crystal panel 621 is equal to resolution of the liquid crystal panel 711 of the color modulation light valve 71. For that reason, the reflection plate 6451 is rotated and first modulated light due to one light-control pixel is moved by one pixel such that the first modulated light becomes incident on a color modulation pixel adjacent to the corresponding color modulation pixel.

In this case, the driving portion 6459 makes the period of reciprocation in each of the ±X directions by one pixel different from the period of reciprocation in each of the ±Y directions by one pixel. Specifically, the driving portion 6459 reciprocates the center of first modulated light due to a certain light-control pixel five times in the ±Y directions for a predetermined period of time while reciprocating the center of first modulated light six times in the ±X directions.

FIG. 9 is a diagram illustrating a locus of the center position of first modulated light due to one light-control pixel, for a predetermined period of time.

As described above, when the reflection plate 6451 is rotated, the center position of first modulated light due to a certain light-control pixel continues to move in a direction inclined to each of the X direction and the Y direction within a range of one pixel in each of the ±X directions and the ±Y directions and returns to the original position at a certain period, as illustrated in FIG. 9.

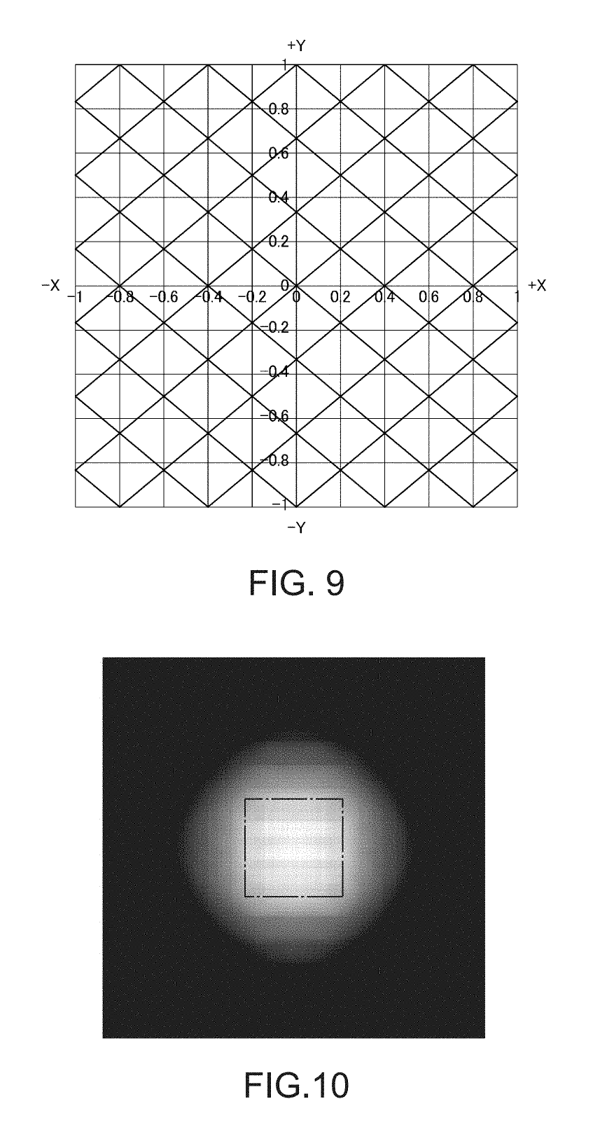

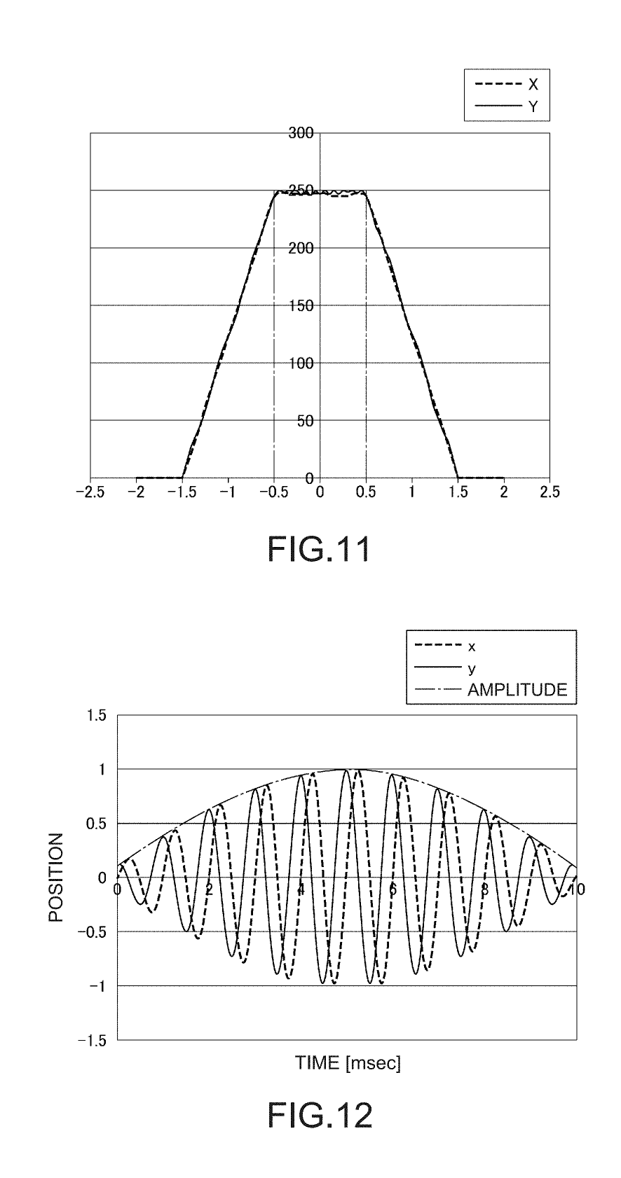

FIG. 10 is a diagram illustrating illuminance distribution of first modulated light due to one light-control pixel and FIG. 11 is a graph illustrating the illuminance distribution. In FIG. 10, an illumination range in a case where the reflection plate 6451 is not rotated, that is, in a case where the center position of first modulated light due to the one light-control pixel is not moved is represented by the one-dot chain line. In FIG. 11, the horizontal axis represents a range irradiated with the first modulated light in a case where the center position before movement of first modulated light due to one light-control pixel is set as “0” and the dimension of one pixel is set as “1”, and the vertical axis represents illuminance (brightness).

As described above, when the center position of first modulated light due to the light-control pixel is moved, first modulated light is incident on a wider range compared to a case where the center position is not moved, as illustrated in FIG. 10.

Specifically, as illustrated in FIG. 11, in a case where the center position of first modulated light due to one light-control pixel is moved, an irradiation range of the first modulated light becomes a range outwardly wider than the case where the center position is not moved (a case of being represented by one-dot chain line in FIG. 11) by one pixel. In the range, illuminance of one pixel at the center is the highest and illuminance becomes lower as it goes to the outside.

As described above, the driving portion 6459 rotates the reflection plate 6451 around the rotation axis along the Y direction in one direction or the other direction to reciprocate the center position of first modulated light due to a certain light-control pixel in the ±X direction. Together with this, the driving portion 6459 rotates the reflection plate 6451 around the rotation axis along the X direction in one direction or the other direction to reciprocate the center position of first modulated light due to the certain light-control pixel in the ±Y direction.

With this, an image of first modulated light is scattered by the reflection member 645 and thus, it is possible to allow illumination distribution due to light incident on the image forming surface 7111 to be illumination distribution which does not depend on light distribution. Accordingly, in addition to matters that it is possible to easily erase the black matrix surrounding the color modulation pixel and prevent moire from occurring, it is possible to prevent a defect such as a stripe which is not originally present in a projection image itself from occurring in the projection image even in a case where change in alignment distribution is generated. Accordingly, it is possible to surely prevent disturbance from occurring in the projection image.

According to the projector according to the present embodiment as described above, the following effects can be obtained in addition to matters that the same effect as that of the projector 1 described above can be obtained.

The reflection plate 6451 having the reflection surface 6452 reflecting first modulated light is rotated around two rotation axes orthogonal to each other by the driving portion 6459. According to this, it is possible to surely scatter first modulated light incident on the reflection surface 6452 so as to make it possible for the first modulated light to be incident on the image forming surface 7111. Accordingly, as described above, it is possible to surely prevent disturbance such as the moire or the streak from occurring in the projection image.

Furthermore, the reflection member 645 rotates the reflection plate 6451 having the flat reflection surface 6452 to scatter the first modulated light. For that reason, it is possible to easily manufacture the reflection plate 6451 compared to a case where the reflection member 643 having the unevenness 6432 is adopted as the reflection plate 6451. Furthermore, since it is possible to prevent generation of diffracted light of 0th order which occurs in a case of using the reflection plate 6451, it is possible to surely scatter first modulated light.

The driving portion 6459 rotates the reflection plate 6451 to thereby make it possible to move the center position of first modulated light for each light-control pixel of the brightness adjustment light valve 62 to everywhere within a movable range of the center position. According to this, it is possible to uniformly illuminate a wide range including the corresponding color modulation pixel by first modulated light for each pixel. Accordingly, it is possible to more surely prevent disturbance from occurring in the image.

### Fifth Embodiment

Next, a fifth embodiment of the invention will be described.

A projector according to the present embodiment has the same configuration as the projector described in the fourth embodiment.

Here, in the projector according to the fourth embodiment, the amount of movement of the center position of first modulated light due to one light-control pixel in the ±X direction and the ±Y direction was 2 pixels, 1-pixel in the + direction and 1-pixel in the − direction. Specifically, in a case where the center position is moved in the ±X direction, when a position before movement in the X direction is set as a reference position, firstly, the center position is moved in the +X direction by one pixel, and then moved to the −X direction and returns to the reference position and also, the center position is moved in the −X direction by one pixel, and then moved to the +X direction and returns to the reference position. A case where the center position is moved in the ±Y direction is also similar.

In contrast, in the projector according to the present embodiment, the amount of movement in one-reciprocal-movement in the ±X direction and the ±Y direction is changed in a fixed period of time. In this regard, the projector according to the present embodiment is different from the projector described in the fourth embodiment. In the following description, the same or substantially the same portions as previously described portions are assigned the same reference numerals and description thereof will be omitted.

FIG. 12 is a time chart illustrating an amount of movement of a center position of first modulated light due to one light-control pixel in the projector according to the present embodiment. Also, in FIG. 12, a case in which the center position is moved in the +X direction and the +Y direction by one pixel is set as “1” and a case in which the center position is moved in the −X direction and the −Y direction by one pixel is set as “−1” are represented.

The projector according to the present embodiment has the same configuration and function as those of the projector described in the fourth embodiment, except that a mode in which the reflection plate 6451 is rotated by the driving portion 6459 so as to move the center position of first modulated light for each light-control pixel is different.

In the present embodiment, as illustrated in FIG. 12, the driving portion 6459 rotates the reflection plate 6451 respectively around the rotation axis along the Y direction and the rotation axis along the X direction in one direction or the other direction to allow the amount of movement when the center position of first modulated light due to the light-control pixel is moved in each of the ±X direction and the ±Y direction to be changed with time.

Specifically, similar to matters described above, although the center position of first modulated light due to each light-control pixel is moved in the ±X direction and the ±Y direction, the amount of movement of the center position in the ±X direction and the ±Y direction is changed like a sin wave (sinusoidal wave) in a range of one pixel to the maximum. That is, the amplitude of the center position in the ±X direction is gradually increased and then gradually decreased, and the amplitude of the center position in the ±Y direction is also gradually increased and then gradually decreased. The amplitudes and periods of the center positions in the ±X direction and the ±Y direction are the same, but phases of respective periods are shifted by 90°.

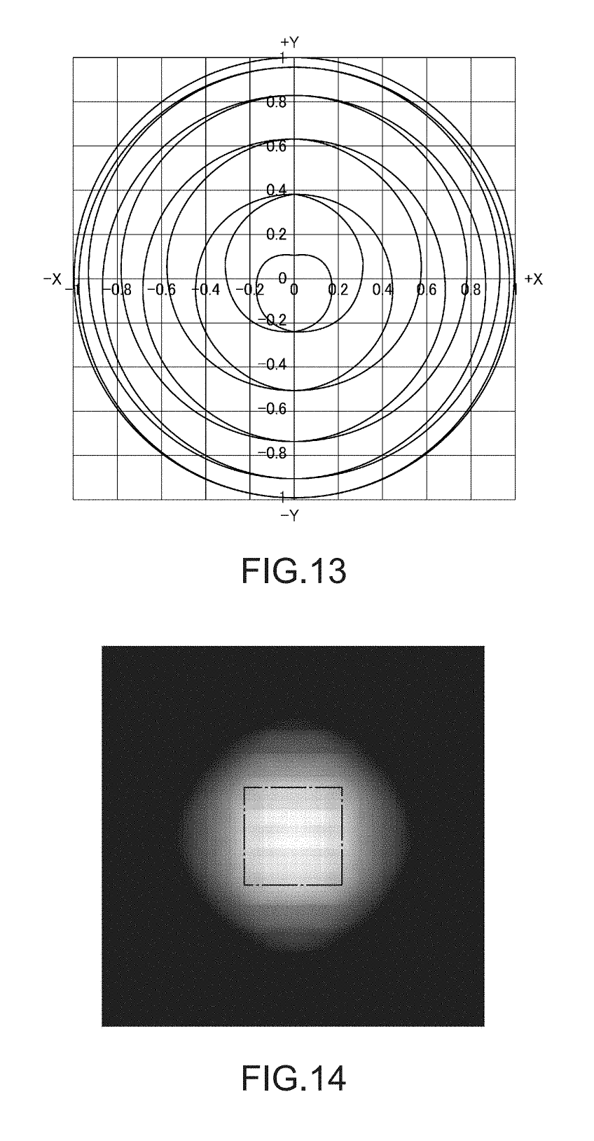

FIG. 13 is a diagram illustrating a locus of the center position of first modulated light due to one light-control pixel, for a predetermined period of time.

As described above, when the reflection plate 6451 is rotated by the driving portion 6459, as illustrated in FIG. 13, the center position of first modulated light due to a certain light-control pixel is moved from a position shifted to a +Y direction side while spreading in a spiral shape and then, moved while similarly reducing in a spiral shape, within a range of one pixel in each of the ±X directions and the ±Y directions and returns to the original position at a certain period.

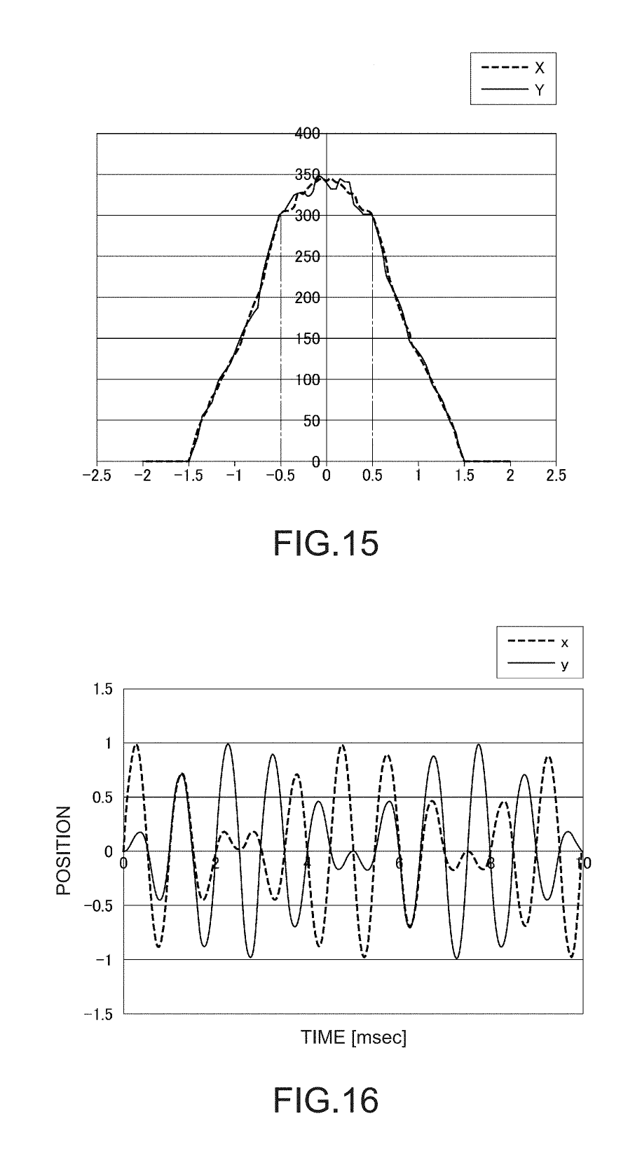

FIG. 14 is a diagram illustrating illuminance distribution of first modulated light due to one light-control pixel and FIG. 15 is a graph illustrating the illuminance distribution. In FIG. 14, similar to FIG. 10, the illumination range in a case where the reflection plate 6451 is not rotated, that is, in a case where the center position of first modulated light due to the one light-control pixel is represented by the one-dot chain line. In FIG. 15, the horizontal axis represents a range irradiated with the first modulated light in a case where the center position before movement of first modulated light due to one light-control pixel is set as “0” and the dimension of one pixel is set as “1”, and the vertical axis represents illuminance (brightness).

As described above, when the center position of first modulated light due to light-control pixel is moved, as illustrated in FIG. 14, the illumination range due to first modulated light is widened compared to a case where the center position is not moved.

Specifically, as illustrated in FIG. 15, in a case where the center position of first modulated light due to a certain light-control pixel is moved, an irradiation range of the first modulated light becomes a range which is outwardly wider than the case where the center position is not moved (a case of being represented by one-dot chain line in FIG. 15) by one pixel. In the range, illuminance of one pixel at the center is the highest and illuminance becomes lower as it goes to the outside. A decreasing rate of illuminance (increasing rate) is lower than a decreasing rate of illuminance (increasing rate) illustrated in FIG. 11 and a going-down curve (going-up curve) of illuminance is more gentle than a going-down curve (going-up curve) of the illuminance illustrated in FIG. 11.

By the configuration as described above, an image of first modulated light due to a certain light-control pixel is scattered by the reflection member 645 and is incident on a wide range centering at a corresponding color modulation pixel. Accordingly, it is possible to allow first modulated light due to one light-control pixel to be incident on a range including a corresponding color modulation pixel and the black matrix surrounding the color modulation pixel.

According to the projector according to the present embodiment, the following effects also can be obtained, in addition to matters that the same effect as that of the projector according to the fourth embodiment can be obtained.

The amplitude, when the center position of first modulated light due to the light-control pixel is moved in the ±X direction and the ±Y direction, is changed with time, like a sin wave. With this, the decrease in illuminance from the illumination range in a case where the center position is not moved to the outside becomes gentle. According to this, it is possible to allow illumination distribution of light incident on the image forming surface 7111 to be blurred illumination distribution which does not depend on alignment distribution. Accordingly, it is possible to prevent disturbance such as moire from occurring in the projection image. It is possible to prevent a stripe which is not originally present in a projection image itself from occurring in the projection image even in a case where deviation in alignment distribution of light incident on the brightness adjustment light valve 62 is generated, due to matters that a discharge light source lamp such as an ultra-high pressure mercury lamp is adopted as a light source, an arc position occurring inside a light-emission portion is deviated from a suitable position due to factors such as degradation, and the like. Accordingly, it is possible to prevent disturbance from occurring in the projected image.

### Variation of Fifth Embodiment

FIG. 16 is a time chart illustrating the amount of movement of the center position of first modulated light due to one light-control pixel in a case where a rotation mode of the reflection plate 6451 is changed from the rotation mode described above. Also, in FIG. 16, a case in which the center position is moved in the +X direction and the +Y direction by one pixel is set as “1” and a case in which the center position is moved in the −X direction and the −Y direction by one pixel is set as “−1” are represented.

In the projector according to the fifth embodiment, the driving portion 6459 rotated the reflection plate 6451 such that the amplitude of the center position of first modulated light due to the light-control pixel in the ±X direction and the ±Y direction is changed with time like a sin wave. However, without being limited to the configuration described above, the driving portion 6459 may rotate the reflection plate 6451 such that the amplitude in at least one of the ±X direction and the ±Y direction is changed with time.

For example, as illustrated in FIG. 16, the driving portion 6459 may rotate the reflection plate 6451.

Specifically, while the amplitude of the center position of first modulated light due to each light-control pixel is subjected to amplitude five times in each of the ±X direction and the ±Y directions, the amount of movement of the center position is gradually increased in a range of one pixel to the maximum and then, is gradually decreased, and the center position is further subjected to amplitude in each of the ±X direction and the ±Y direction five times by reversing the amount of movement in the + direction and the amount of movement in the − direction. In a case where a total of ten times of five times each is set as one period, the phase at the amplitude in the ±X direction is shifted by a ¼ period with respect to the phase at the amplitude in the ±Y direction. In other words, the amplitude in the ±Y direction is started after the time according to a ¼ period is elapsed from the time at which the amplitude in the ±X direction is started in a state where the time according to one period is the same.

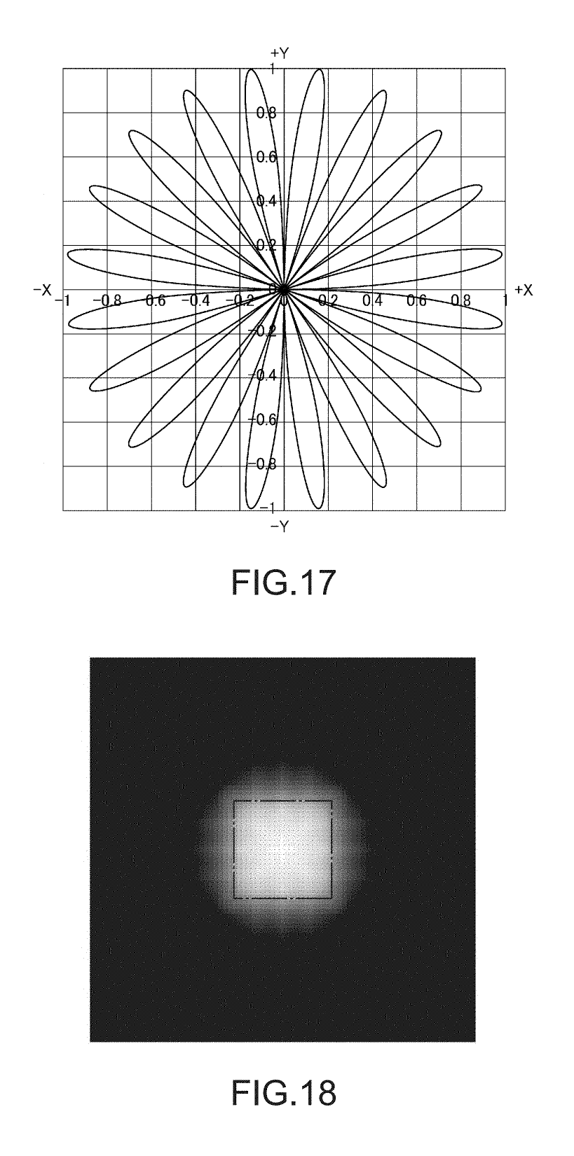

FIG. 17 is a diagram illustrating a locus of the center position of first modulated light due to one light-control pixel for a predetermined period of time.

As described above, when the reflection plate 6451 is rotated by the driving portion 6459, as illustrated in FIG. 17, the center position of the first modulated light due to a certain light-control pixel is moved so as to draw a locus of a flower form (floral pattern) using the center thereof as a starting point within a range of one pixel in each of the ±X direction and the ±Y direction.

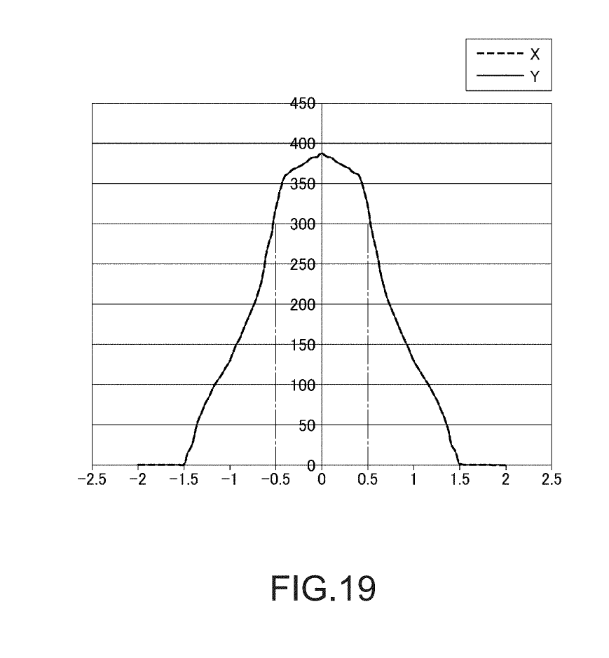

FIG. 18 is a diagram illustrating illuminance distribution of first modulated light due to one light-control pixel and FIG. 19 is a graph illustrating the illuminance distribution. In FIG. 18, similar to FIG. 10, the illumination range in a case where the reflection plate 6451 is not rotated, that is, in a case where the center position of first modulated light due to one light-control pixel is not moved, is represented by one-dot chain line. In FIG. 19, the horizontal axis represents a range irradiated with the first modulated light in a case where the center position before movement of first modulated light due to one light-control pixel is set as “0” and the dimension of one pixel is set as “1”, and the vertical axis represents illuminance (brightness).

As described above, when the center position of first modulated light due to the light-control pixel is moved, as illustrated in FIG. 18, the illumination range due to first modulated light is widened compared to a case where the center position is not moved.

Specifically, as illustrated in FIG. 19, in a case where the center position of first modulated light due to a certain light-control pixel is moved, an irradiation range of the first modulated light becomes a range outwardly wider than the case where the center position is not moved (a case of being represented by one-dot chain line in FIG. 19) by one pixel. In the range, illuminance of one pixel at the center is the highest and illuminance becomes lower as it goes to the outside. A decreasing rate of illuminance (increasing rate) is lower than the decreasing rate of illuminance (increasing rate) illustrated in FIG. 11 and becomes a value close to the decreasing rate of illuminance (increasing rate) illustrated in FIG. 15. That is, the going-down curve (going-up curve) of the illuminance is more gentle than the going-down curve (going-up curve) of the illuminance illustrated in FIG. 11 and is similar to the going-down curve (going-up curve) of the illuminance illustrated in FIG. 15.

By the configuration as described above, the image of the first modulated light due to a certain light-control pixel is scattered by the reflection member 645 and is incident on a wide range around the corresponding color modulation pixel. Accordingly, it is possible to allow first modulated light due to one light-control pixel to be incident on the range including the corresponding color modulation pixel and the black matrix surrounding the color modulation pixel.

As described above, the same effect as the above can be obtained by the projector in which the driving portion 6459 rotates the reflection plate 6451.

### Sixth Embodiment

Next, a sixth embodiment of the invention will be described.

A projector according to the present embodiment has the same configuration as that of the projector 1, but is different from the projector 1 described above in that an arrangement of optical components differs. In the following description, the same or substantially the same portions as previously described portions are assigned the same reference numerals and description thereof will be omitted.

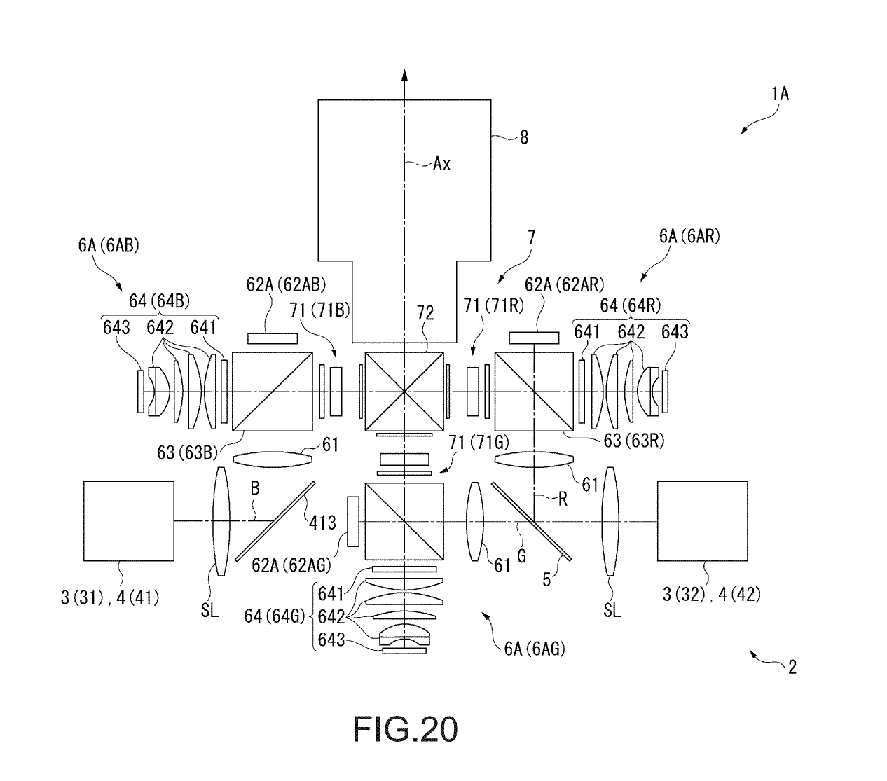

FIG. 20 is a schematic diagram illustrating a configuration of a projector 1A according to the present embodiment.

As illustrated in FIG. 20, the projector 1A according to the present embodiment has the same configuration and function as those of the projector 1 described above except that instead of the light-control device 6, the light-control device 6A is included.

The light-control device 6A includes a light-control device 6AB for blue which adjusts brightness of the blue light beam B, which is incident through the first uniformizing device 41 and a lens SL from the first light source device 31, for each pixel and a light-control device 6AG for green and a light-control device 6R for red which respectively adjust brightness of the green light beam G and red light beam R, which are respectively emitted from the second light source device 32, passed through the second uniformizing device 42 and the lens SL, and separated by the color separation device 5, for each pixel. Although the light-control device 6A (6AB, 6AG, 6AR) has the same configuration and function as those of the light-control device 6, an arrangement of respective devices constituting the light-control device 6A is different from that of the light-control device 6.

Specifically, the light-control device 6A includes the field lens 61, a brightness adjustment light valve 62A, the polarization separation device 63, and the relay device 64.

Among these components, the polarization separation device 63 transmits light incident from the field lens 61 so as to be incident on the brightness adjustment light valve 62A, reflects first modulated light incident from the brightness adjustment light valve 62A so as to be incident on the relay device 64, and transmits the first modulated light incident from the relay device 64 so as to be incident on the corresponding color modulation light valve 71.

The brightness adjustment light valve 62A (brightness adjustment light valves for blue, green, and red are respectively referred to as 62AB, 62AG, and 62AR) is configured with a reflection type liquid crystal panel controlled by the control device. The brightness adjustment light valve 62A modulates light incident from the polarization separation device 63 according to image information on the way of reflecting the light to the polarization separation device 63. First modulated light which is light modulated by the brightness adjustment light valve 62A and of which the light amount is adjusted for each light-control pixel, is incident on the corresponding color modulation light valve 71 through the polarization separation device 63 and the relay device 64. That is, the first modulated light is incident on the liquid crystal panel 711 through the incidence side polarization plate 712 of the color modulation light valve 71 and is further modulated according to image information.

The same effect as that of the projector 1 described above can be obtained also by the projector 1A including the light-control device 6A described above.

Instead of the reflection member 643 constituting the relay device 64, the reflection member 643A may be adopted or a reflection member configured by the deformable mirror may also be adopted. Furthermore, instead of the reflection member 643, the reflection member 644 or the reflection member 645 may be adopted.

### Seventh Embodiment

Next, a seventh embodiment of the invention will be described.

A projector according to the present embodiment has the same configuration as that of the projector 1A described above, but an optical path of light passing through the light control device is different, in addition to matters that configurations of the illumination device and the color separation device differ. In this regard, the projector according to the present embodiment is different from the projector 1A described above. In the following description, the same or substantially the same portions as previously described portions are assigned the same reference numerals and description thereof will be omitted.

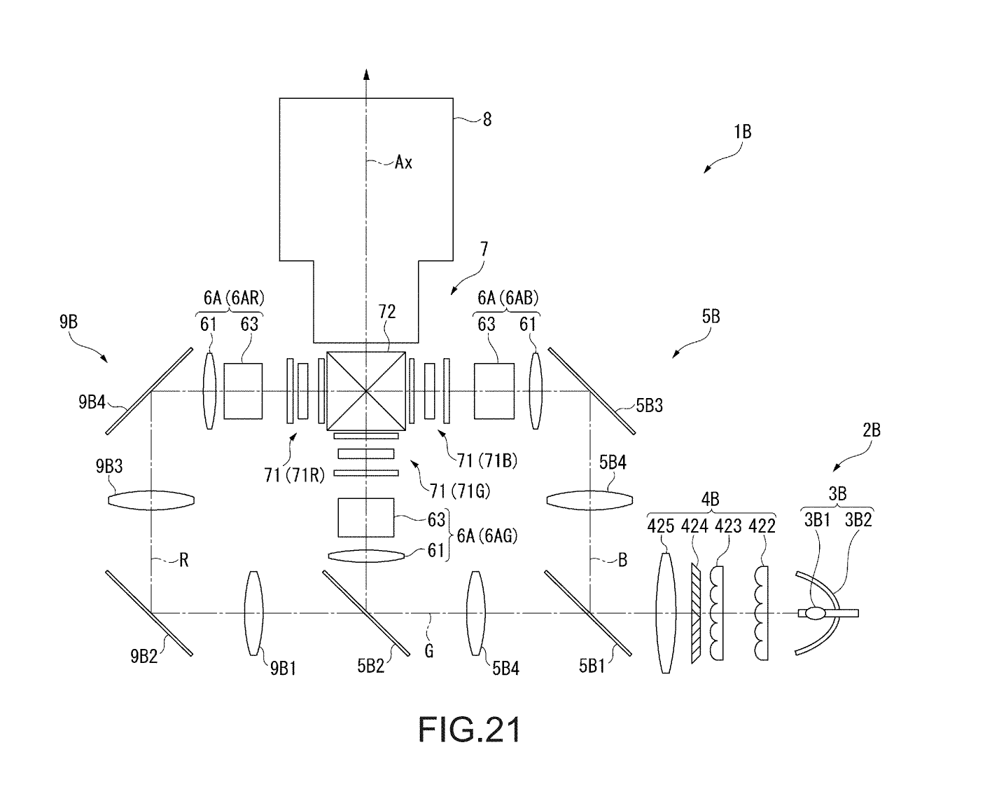

FIG. 21 is a plan view schematically illustrating a configuration of a projector 1B according to the present embodiment.

As illustrated in FIG. 21, the projector 1B according to the present embodiment includes an illumination device 2B, a color separation device 5B, the light-control device 6A (6AB, 6AG, 6AR), the image forming device 7, the projection optical device 8, a transfer device 9B, and an outer casing (not illustrated) accommodating these devices inside thereof. In addition to the devices, although illustration is omitted, the projector 1B includes the control device, the power supply device, and the cooling device.

The illumination device 2B includes a light source device 3B and a uniformizing device 4B and emits light toward the color separation device 5B.

The light source device 3B includes a light source lamp 3B1 such as an ultra-high pressure mercury lamp and a reflector 3B2 reflecting light emitted from light source lamp 3B1 toward the uniformizing device 4B.

The uniformizing device 4B uniformizes illuminance distribution (brightness distribution) within a plane orthogonal to the central axis of light incident from the light source device 3B. Similar to the second uniformizing device 42, the uniformizing device 4B includes the first lens array 422, the second lens array 423, the polarization conversion element 424, and the superimposed lens 425.

The color separation device 5B separates color light beams of blue, green, and red from light incident from the illumination device 2B. The color separation device 5B includes dichroic mirrors 5B1 and 5B2, a total reflection mirror 5B3, and two convex lenses 5B4.

The dichroic mirror 5B1 reflects blue light beam B included in light incident from the illumination device 2B and transmits the green light beam G and red light beam R.

The dichroic mirror 5B2 reflects the green light beam G and transmits the red light beam R, among the green light beam G and the red light beam R transmitted through the dichroic mirror 5B1.

The blue light beam B reflected by the dichroic mirror 5B1 is incident on the total reflection mirror 5B3, and the total reflection mirror 5B3 reflects the blue light beam B toward the light-control device 6AB for blue.

Two convex lenses 5B4 are respectively provided between the dichroic mirrors 5B1 and 5B2 and between the dichroic mirror 5B1 and the total reflection mirror 5B3.

The transfer device 9B is provided on the optical path of the red light beam R transmitted through the dichroic mirror 5B2 and guides the red light beam R to the light-control device 6A (6AR) for red. The transfer device 9B includes an incidence side lens 9B1, a reflection mirror 9B2, a relay lens 9B3, and a reflection mirror 9B4.

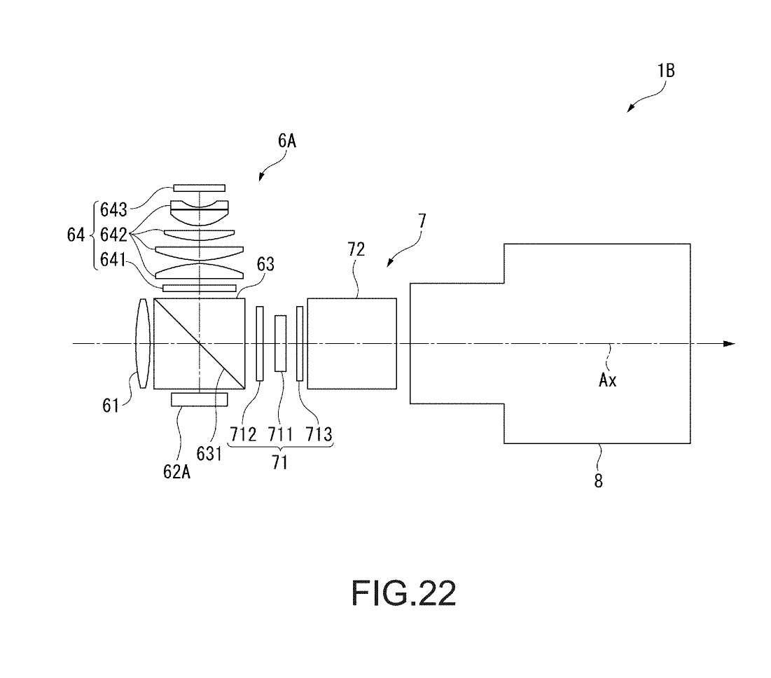

FIG. 22 is a diagram illustrating an optical path in a light-control device 6A included in the projector 1B.

As described above, the light-control device 6A (6AB, 6AG, and 6AR) causes first modulated light, which is obtained by subjecting respective incident color light beams to modulation and adjusting the light amount for each light-control pixel, to be incident on the corresponding color modulation light valve 71 (71B, 71G, and 71R). As illustrated in FIG. 22, the light-control device 6A includes the field lens 61, the brightness adjustment light valve 62A, the polarization separation device 63, and the relay device 64.

Among these components, the brightness adjustment light valve 62A and the relay device 64 are positioned at one side and the other side along the normal line of a virtual plane, in which central axes of color light beams of blue, green, and red separated by the color separation device 5B are included, with respect to the polarization separation device 63. Specifically, the brightness adjustment light valve 62A is positioned at a lower side with respect to the polarization separation device 63 and the relay device 64 is positioned at an upper side with respect to the polarization separation device 63. An arrangement of these components may be reversed.

For that reason, polarized light of which the direction is made uniform to one polarization direction by the polarization conversion element 424 and is incident on the polarization separation device 63 through the field lens 61 is reflected by the polarization separation layer 631 and is incident on the brightness adjustment light valve 62A. First modulated light (light of which light amount is adjusted for each light-control pixel), which is modulated according to reflection by the light-control pixel of the brightness adjustment light valve 62A, is transmitted through the polarization separation layer 631 and is incident on the relay device 64. The image of first modulated light incident on the polarization separation device 63 again from the relay device 64 is reflected by the polarization separation layer 631 and is formed on the image forming surface 7111 of the color modulation light valve 71 positioned at the rear stage in the optical path of the polarization separation device 63.

As described above, the image forming device 7 includes three color modulation light valves 71 (71B, 71G, and 71R) according to respective color light beams B, G, and R and the color combining device 72. Second modulated light beams of respective colors, which are first modulated light beams modulated by these color modulation light valve 71, are combined by the color combining device 72 and projected by the projection optical device 8.

The same effect as that of the projector 1 described above can be obtained by also the projector 1B having the configuration as described above.

Instead of the reflection member 643 constituting the relay device 64, the reflection member 643A may be adopted and a reflection member configured by the deformable mirror may be adopted. Furthermore, instead of the reflection member 643, the reflection member 644 or the reflection member 645 may also be adopted.

### Eighth Embodiment

Next, an eighth embodiment of the invention will be described.

A projector according to the present embodiment has the same configuration as that of the projector 1. Here, in the projector 1, three light-control devices 6 were provided and the color combining device 72 combined and emitted second modulated light of respective colors modulated by three transmission type color modulation light valves 71.

In contrast, the projector according to the present embodiment has a configuration in which the color combining device 72 separates three color light beams from incident light and emits color light beams to three reflection type color modulation light valves, and the color combining device 72 combines and emits respective color light beams incident from respective color modulation light valves, in addition to matters that one light-control device 6 is included. In this regard, the projector according to the present embodiment is different from the projector 1 described above. In the following description, the same or substantially the same portions as previously described portions are assigned the same reference numerals and description thereof will be omitted.

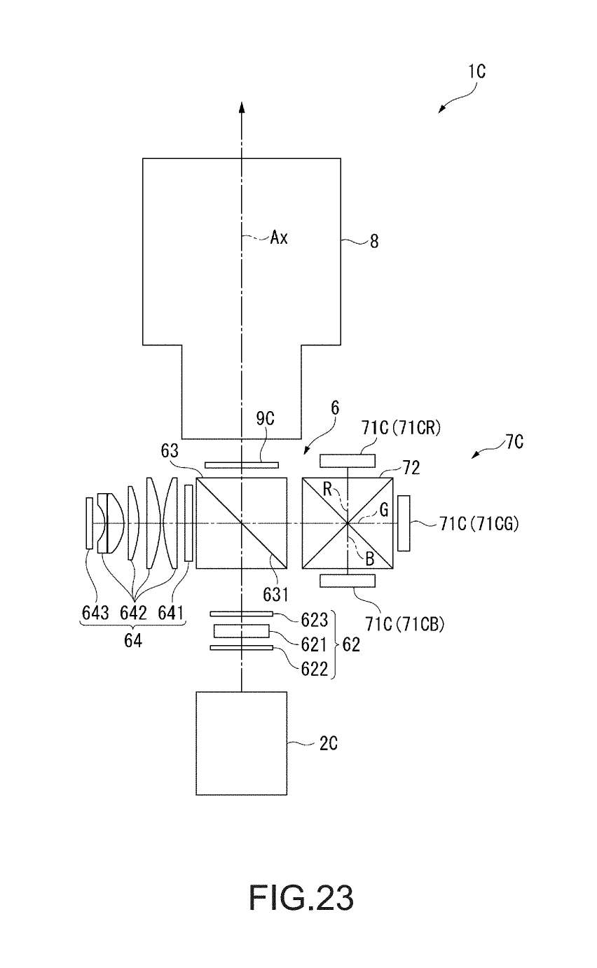

FIG. 23 is a schematic diagram illustrating a configuration of a projector 1C according to the present embodiment.

As illustrated in FIG. 23, the projector 1C according to the present embodiment includes an illumination device 2C, the light-control device 6, an image forming device 7C, a polarization plate 9C, and the projection optical device 8.

The illumination device 2C emits light, which is a sort of linearly polarized light and of which illuminance distribution within the plane orthogonal to the optical axis is uniformized, toward the light-control device 6. Such an illumination device 2C may have the same configuration as that of the illumination device 2B, for example. Furthermore, the illumination device 2C may be configured to include the light source device 3 and the second uniformizing device 42 and obtain light, of which the illuminance distribution is uniformized, on the way of allowing respective color light beams of blue, green, and red emitted from the light source device 3 to pass through the second uniformizing device 42.

In the light-control device 6, the brightness adjustment light valve 62 modulates light incident from the illumination device 2C and causes first modulated light, for which light amount is adjusted for each light-control pixel, to be incident on the polarization separation device 63.

The polarization separation device 63 reflects first modulated light incident from the brightness adjustment light valve 62 by the polarization separation layer 631 to be emitted toward the relay device 64.

In the relay device 64, light incident from the polarization separation device 63 is scattered by the reflection member 643 and the image of incident first modulated light is formed on the image forming surface 7111 of each color modulation light valve 71C by the image forming lens 642. As described above, first modulated light incident on the relay device 64 is passed through the phase difference plate 641 two times to thereby cause a polarization direction to be rotated by 90°, is passed through the polarization separation layer 631, and is incident on the image forming device 7C.

In the image forming device 7C, the color combining device 72 separates respective color light beams B, G, and R of blue, green, and red from first modulated light which is incident from the light-control device 6 and causes the color light beams B, G, and R to be incident on the color modulation light valve 71C. The color modulation light valves 71C (71CB, 71CG, and 71CR) are the reflection type liquid crystal panels and are respectively provided for each color light beam. These color modulation light valves 71C modulate the incident color light beams on the way of reflecting the color light beams and causes the incident color light beams to be incident on the color combining device 72 again as second modulated light. The color combining device 72 combines second modulated light of respective colors and causes second modulated light to be incident on the polarization separation device 63 again.

The second modulated light incident on the polarization separation device 63 is reflected onto a projection optical device 8 side by the polarization separation layer 631. The polarization plate 9C transmitting second modulated light modulated by the color modulation light valve 71C and absorbing other polarized light is disposed between the polarization separation device 63 and the projection optical device 8. Second modulated light incident on the projection optical device 8 through the polarization plate 9C is enlarged and projected on the surface to be projected by the projection optical device 8.

Even by the projector 1C having the configuration described above, the same effect as that of the projector 1 described above can be obtained.

Instead of the reflection member 643 constituting the relay device 64, the reflection member 643A may be adopted and the reflection member configured by the deformable mirror may be adopted. Furthermore, instead of the reflection member 643, the reflection member 644 or the reflection member 645 may be adopted.

### Ninth Embodiment

Next, a ninth embodiment of the invention will be described.

A projector according to the present embodiment is different from the projector 1 described above in that the illumination device and the color separation device are disposed at the upper stage and the light control device, the image forming device, and the projection optical device are disposed at the lower stage. In the following description, the same or substantially the same portions as previously described portions are assigned the same reference numerals and description thereof will be omitted.

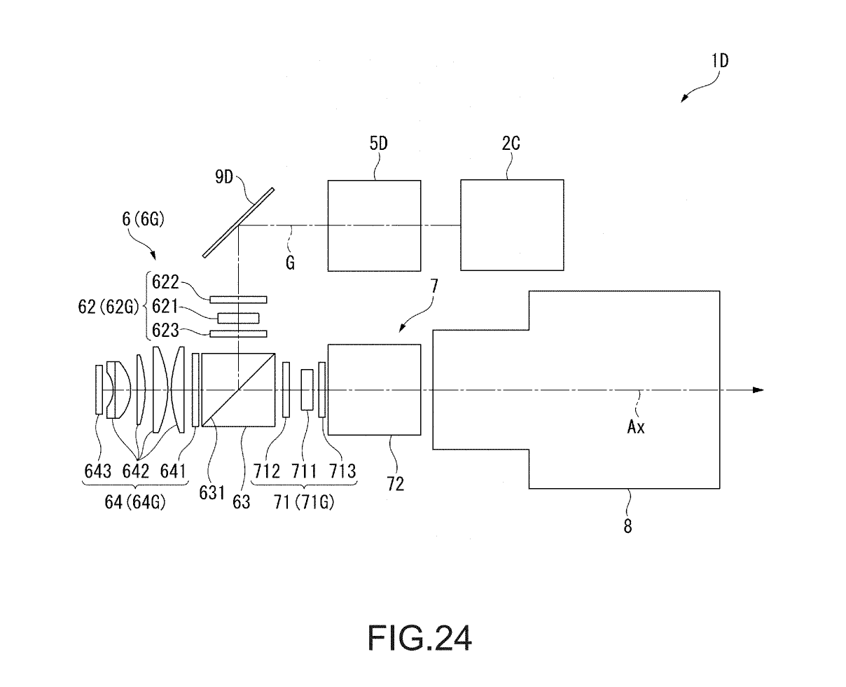

FIG. 24 is a schematic diagram of an internal structure of a projector 1D according to the present embodiment when viewed from a side.

As illustrated in FIG. 24, the projector 1D according to the present embodiment includes the illumination device 2C, a color separation device 5D, total reflection mirrors 9D, the light-control device 6, the image forming device 7, the projection optical device 8, and an outer casing (not illustrated) accommodating these devices inside thereof. Furthermore, although illustration is omitted, the projector 1D includes the control device, the power supply device, and the cooling device.

Among these components, the illumination device 2C, the color separation device 5D, and the total reflection mirrors 9D are disposed at the upper stage and three light-control devices 6, the image forming device 7, and the projection optical device 8 are disposed at the lower stage. The respective color light beams B, G, and R of blue, green, and red separated by the color separation device 5D disposed at the upper stage are respectively reflected by the total reflection mirrors 9D and guided to the light-control device 6 (6B, 6G, and 6R) positioned at the lower stage.

In the following, configurations of these components will be described.

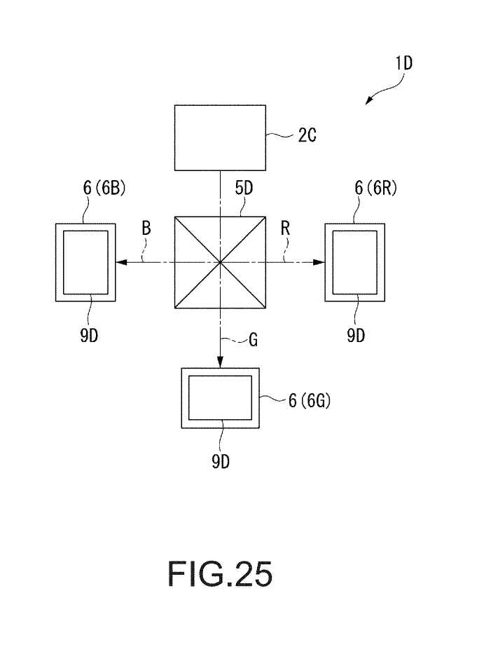

FIG. 25 is a plan view illustrating the illumination device 2C, the color separation device 5D, and the total reflection mirrors 9D that are positioned at the upper stage.

Light (light which is sort of linearly polarized light and of which illuminance distribution within the plane orthogonal to the optical axis is uniformized) emitted from the illumination device 2C is incident on the color separation device 5D as illustrated in FIG. 25.

The color separation device 5D is configured by a cross dichroic prism, inside of which two sorts of dielectric multilayer films are disposed by being intersected with each other, and separates color light beams B, G, and R of blue, green, and red from light which is incident from the illumination device 2C. The green light beam G separated as described above is passed through the color separation device 5D and reflected to the lower stage side by the total reflection mirrors 9D, and the blue light beam B and the red light beam Rare respectively reflected to opposite sides by the two sorts of dielectric multilayer films, are caused to be incident on the corresponding total reflection mirror 9D, and are reflected to the lower stage side by the total reflection mirrors 9D.

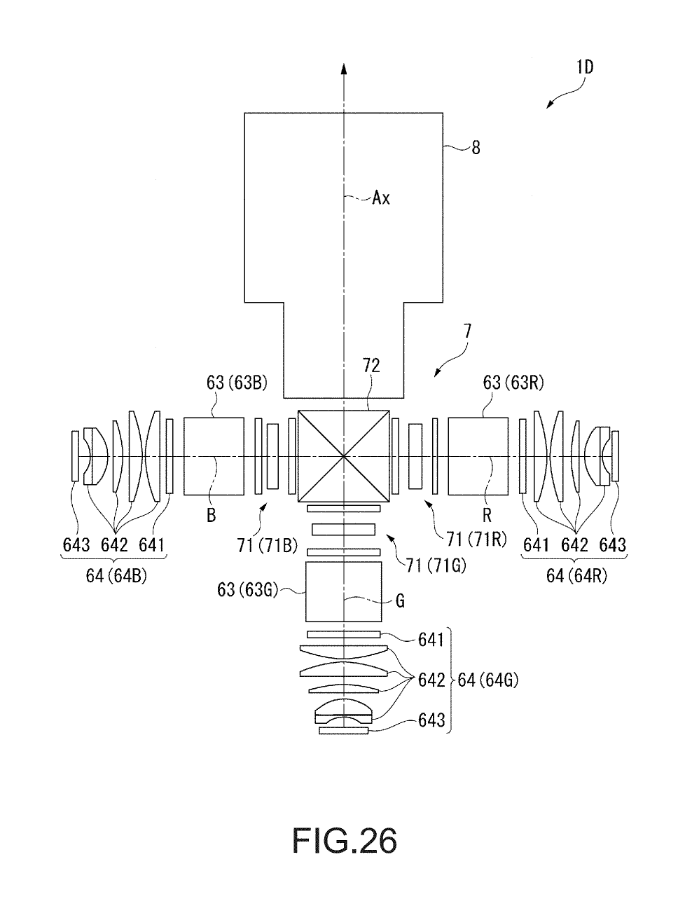

FIG. 26 is a plan view illustrating the light-control device 6 (6B, 6G, and 6R), the image forming device 7, and the projection optical device 8 respectively positioned at the lower stage.

The color light beams B, G, and R reflected by respective total reflection mirrors 9D are respectively incident on the corresponding light-control device 6.

First modulated light, which is modulated for each pixel by each brightness adjustment light valve 62 of the light-control device 6 and of which the light amount is adjusted, is incident on the corresponding color modulation light valve 71 (71B, 71G, and 71R) through the polarization separation device 63 and the relay device 64, as illustrated in FIG. 26.

Second modulated light beams of respective colors modulated according to image information by the color modulation light valves 71B, 71G, and 71R are incident on the color combining device 72 to be combined and each combined color light beam is enlarged and projected on the surface to be projected by the projection optical device 8.

The same effect as that of the projector 1 described above can be obtained even by the projector 1D having the configuration as described above.

Instead of the reflection member 643 constituting the relay device 64, the reflection member 643A may be adopted or a reflection member configured by the deformable mirror may also be adopted. Furthermore, instead of the reflection member 643, the reflection member 644 or the reflection member 645 may be adopted. Instead of the light-control device 6 provided with the brightness adjustment light valve 62 including a transmission type liquid crystal panel, the light-control device 6A provided with the brightness adjustment light valve 62A including a reflection type liquid crystal panel may also be adopted.

### Tenth Embodiment

Next, a tenth embodiment of the invention will be described.

A projector 1E according to the present embodiment is different from the projector 1D described above in that a configuration of the light-control device differs between the projectors. In the following description, the same or substantially the same portions as previously described portions are assigned the same reference numerals and description thereof will be omitted.

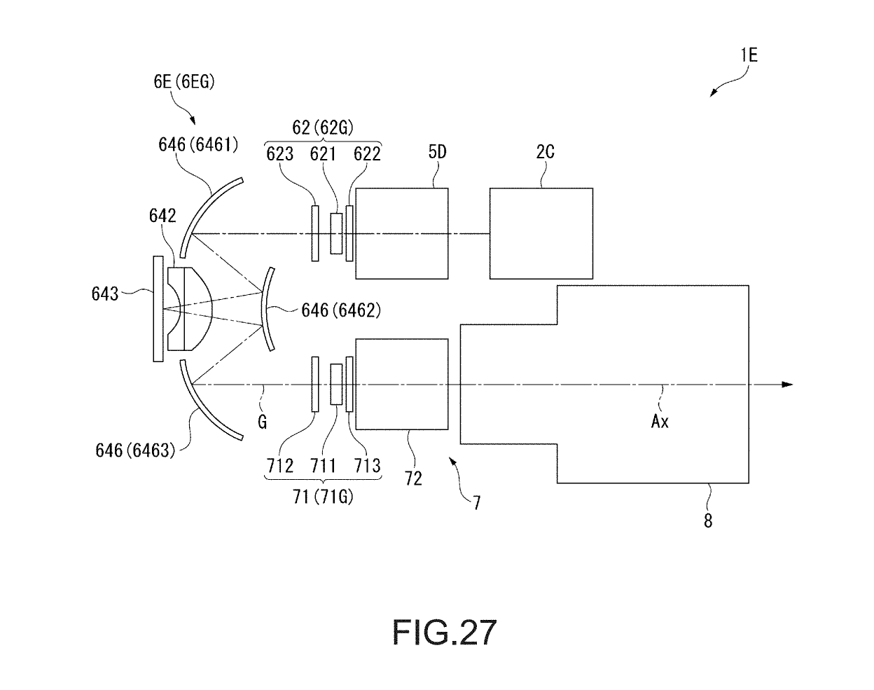

FIG. 27 is a schematic diagram of an internal structure of the projector 1E according to the present embodiment when viewed from a side.

As illustrated in FIG. 27, the projector 1E according to the present embodiment has the same configuration and function as those of the projector 1D described above except that instead of the light-control devices 6, light-control devices 6E are included.

Respective light-control devices 6E (light-control devices for blue, green, and red are respectively referred to as 6EB, 6EG, and 6ER) include the brightness adjustment light valve 62 and the relay device 64, but are different from the light-control devices 6 in that the light-control devices 6E do not include the polarization separation device 63 and also the relay device 64 does not include the phase difference plate 641. Each of the light-control device 6E includes three total reflection mirrors 646 and total reflection mirrors 6461 and 6463 having a concave and curved surface shape and a total reflection mirror 6462 having a convex and curved surface shape are included in the three total reflection mirrors 646.

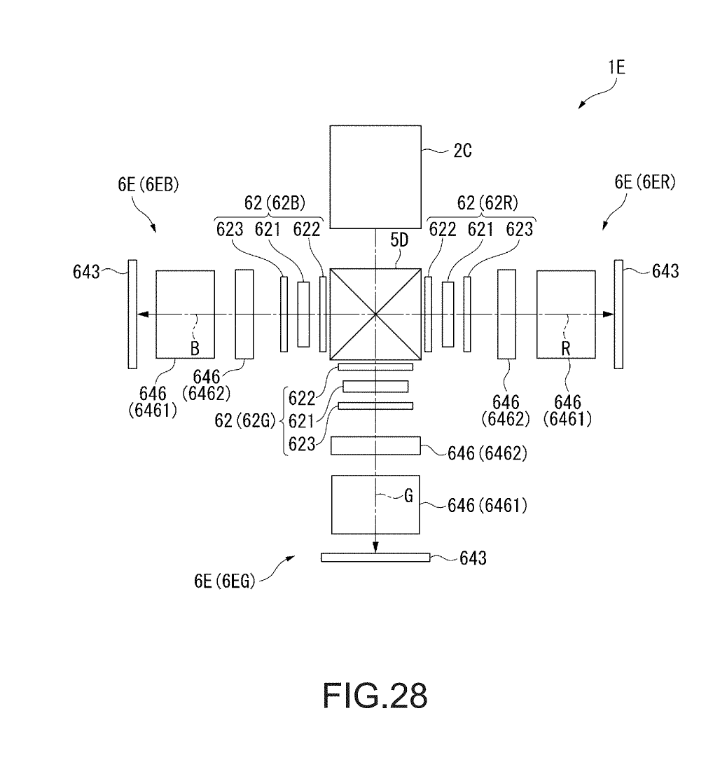

FIG. 28 is a plan view illustrating a portion of the illumination device 2C, the color separation device 5D, and the light-control devices 6E positioned at the upper stage.

In the projector 1E described above, as illustrated in FIG. 27 and FIG. 28, light (light which is sort of linearly polarized light and of which illuminance distribution within the plane orthogonal to the optical axis is uniformized) emitted from the illumination device 2C is incident on the color separation device 5D.

As described above, the color separation device 5D separates color light beams B, G, and R of blue, green, and red from light which is incident from the illumination device 2C. Among the color light beams, the green light beam G is passed through the color separation device 5D and is incident on the brightness adjustment light valve 62G of the light-control device 6EG. As illustrated in FIG. 28, the blue light beam B and red light beam R are respectively reflected to opposite sides by the two sorts of dielectric multilayer films and are respectively incident on the brightness adjustment light valves 62B and 62R of the light-control devices 6EB and 6EG.

Among the color light beams, as illustrated in FIG. 27, first modulated light of green modulated by the brightness adjustment light valve 62G is reflected by the total reflection mirror 6461 having a concaved and curved surface shape and is incident on the total reflection mirror 6462 having a convex and curved surface shape and positioned at an intermediate stage. The total reflection mirror 6462 reflects incident first modulated light toward the image forming lens 642. First modulated light beam is incident on the image forming lens 642 and the reflection member 643 respectively positioned at the intermediate stage, is reflected by reflection member 643, is passed through the image forming lens 642 again, and is incident on the total reflection mirror 6462 again and is reflected. First modulated light reflected again by the total reflection mirror 6462 is further reflected by the total reflection mirror 6463 which is disposed to face the total reflection mirror 6462 at the lower stage and is incident on the corresponding color modulation light valve 71G.

Although illustration is omitted, first modulated light of blue and first modulated light of red modulated by the brightness adjustment light valve 62B and 62R are also similarly passed through the light-control devices 6EB and 6EG and are incident on the corresponding color modulation light valves 71B and 71R, respectively.

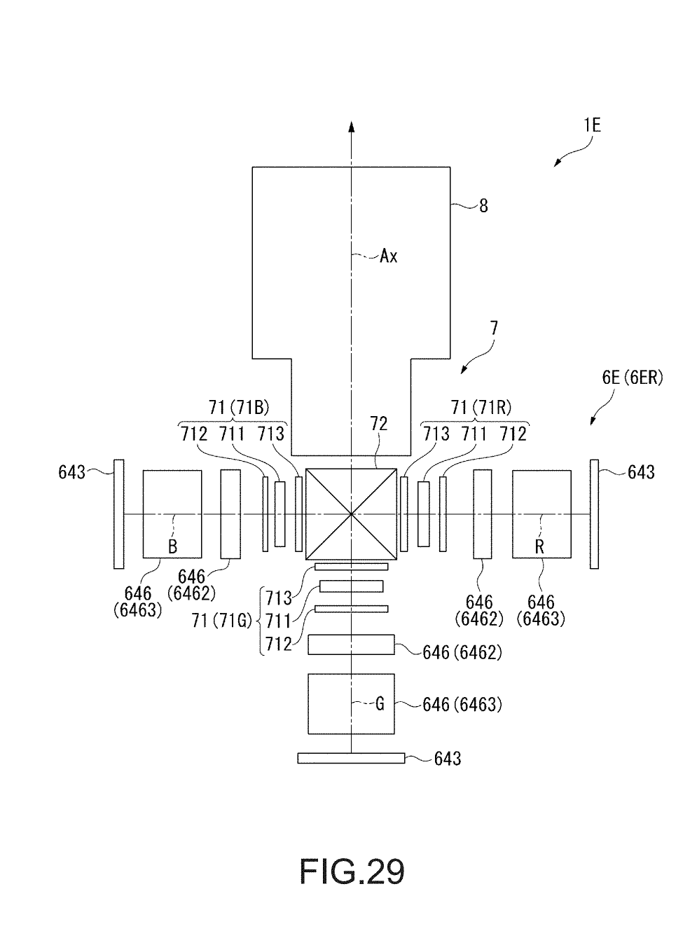

FIG. 29 is a plan view illustrating a portion of the light-control device 6E (6EB, 6EG, and 6ER), the image forming device 7, and the projection optical device 8 that are respectively positioned at the lower stage.

As illustrated in FIG. 29, the first modulated light beams of respective colors that are incident on respective color modulation light valves 71B, 71G, and 71R, are modulated by corresponding respective color modulation light valves 71B, 71G, and 71R and are emitted as second modulated light beams of respective colors. These second modulated light beams of respective colors are combined by the color combining device 72, the combined second modulated light beams of respective colors are enlarged and projected on the surface to be projected by the projection optical device 8.

The same effect as that of the projector 1D described above can be obtained by the projector 1E having the configuration as described above.

Instead of the reflection member 643 constituting the relay device 64, the reflection member 643A may be adopted and a reflection member configured by the deformable mirror may be adopted. Furthermore, instead of the reflection member 643, the reflection member 644 or the reflection member 645 may also be adopted.

### Variation of Embodiment

The invention is not limited to the embodiments described above and variations and improvements within a range capable of achieving the object of the invention are included in the invention.

In the first embodiment, the unevenness 6432 formed on the reflection surface 6431 of the reflection member 643 was fine and random unevenness and in the variation of the first embodiment, the unevenness 6432 was formed in the convex lens shape. However, the invention is not limited thereto. That is, the shape of unevenness formed on the reflection surface can be suitably changed. However, unevenness which scatters first modulated light due to one light-control pixel is fine unevenness.

In the fourth and fifth embodiments, the reflection surface 6452 was formed flatly. However, the invention is not limited thereto. That is, unevenness may be formed also on the reflection surface 6452.

In the fourth and fifth embodiments, the driving portion 6459 rotates (vibrates) the reflection plate 6451 around the rotation axis along the Y direction and the rotation axis along the X direction in one direction or the other direction and the center position of first modulated light was subjected to amplitude in the ±X direction and the ±Y direction. However, the invention is not limited thereto. For example, a configuration in which the reflection plate 6451 is rotated (vibrated) around only one of the two rotation axes may be adopted.

In the fourth embodiment, the periods of reciprocation of the center position of first modulated light are made different respectively in the ±X directions and the ±Y directions. However, the invention is not limited thereto. For example, the periods of reciprocation may be respectively the same and even in a case of being different, the period is not limited to the period described above and can be suitably changed.

In the fifth embodiment, the amount of movement of the center position of first modulated light was changed with time like a sin wave. However, the invention is not limited thereto. For example, change in the amount of movement of the center position with time may be a mode indicated as a modification of fifth embodiment, and the amount of movement may be randomly changed with time. That is, change in the amount of movement of the center position with time may also be another mode of change in the amount of movement of the center position.

The arrangement of optical components in each of the embodiments is an example, and another configuration and arrangement may be adopted.

### REFERENCE SIGNS LIST

1, 1A, 1B, 1C, 1D, and 1E: projector
3, 3B: light source device
(62B, 62G, and 62R), 62A (62AB, 62AG, and 62AR): brightness adjustment light valve (first optical modulation device)
(64B, 64G, and 64R): relay device
642: image forming lens
643, 643A, 644, 645: reflection member
6431, 6452: reflection surface
6432: unevenness
6459: driving portion
71 (71B, 71G, and 71R), 71C (71CB, 71CG, and 71CR): color modulation light valve (second optical modulation device)
8: projection optical device

1. A projector comprising:
a light source device;
a first optical modulation device that modulates light emitted from the light source device and emits the light as first modulated light;
a second optical modulation device that modulates the first modulated light and emits the first modulated light as second modulated light;
a optical projection device that projects the second modulated light; and
a relay device that is provided on an optical path between the first optical modulation device and the second optical modulation device,
wherein the relay device includes an image forming lens which forms an image of the first modulated light on a modulation surface of the second optical modulation device and a reflection member disposed at a pupil position of the image forming lens and reflecting the incident first modulated light, and
the reflection member scatters the first modulated light.

2. The projector according to claim 1,
wherein the reflection member includes a reflection surface reflecting the incident first modulated light, and
unevenness is formed on the reflection surface.

3. The projector according to claim 2,
wherein the unevenness formed on the reflection surface is a curved surface shape.

4. The projector according to claim 2,
wherein the reflection member is a deformable mirror in which the unevenness of the reflection surface is variable.

5. The projector according to claim 1,
wherein the reflection member includes
a reflection surface reflecting the incident first modulated light, and
a driving portion rotating the reflection surface around a first rotation axis along a first direction which intersects with a central axis of the incident first modulated light.

6. The projector according to claim 5,
wherein the driving portion rotates the reflection surface around each of the first rotation axis along the first direction and a second rotation axis along a second direction which is substantially orthogonal to the first rotation axis, and
a frequency of rotation around the first rotation axis is different from the frequency of rotation around the second rotation axis.

7. The projector according to claim 6,
wherein the driving portion changes at least one of an amount of rotation of the reflection surface around the first rotation axis and an amount of rotation of the reflection surface around the second rotation axis with the lapse of time.
